(19) United States
(12) Patent Application Publication
(10) Pub. No.: US 2025/0048202 A1
(43) Pub. Date: Feb. 6, 2025

(54) Supervision Timers for Successful Handover Reporting

(71) Applicant: Telefonaktiebolaget LM Ericsson (publ), Stockholm (SE)

(72) Inventors: Pradeepa Ramachandra, Linköping (SE); Marco Belleschi, Solna (SE); Ali Parichehrehteroujeni, Svärtinge (SE)

(21) Appl. No.: 18/723,600

(22) PCT Filed: Jan. 10, 2023
(86) PCT No.: PCT/SE2023/050025

§ 371 Date: Jun. 24, 2024

Related U.S. Application Data
(60) Provisional application No. 63/297,982, filed on Jan. 10, 2022.

(51) Int. Cl. H04W 36/00; H04W 36/08

(52) U.S. Cl. CPC H04W 36/00833; H04W 36/0058; H04W 36/08

(57) ABSTRACT

Embodiments include methods for user equipment (UE) to provide successful handover reports to a radio access network (RAN). Such methods include receiving, from the RAN, a configuration for successful handover reporting (SHR) by the UE. The SHR configuration includes a single supervision timer threshold that is associated with all measurement objects configured for the UE. Such methods include, upon transmitting to the RAN a measurement report associated with a first one of the measurement objects, initiating a supervision timer based on an initial time value associated with the first measurement object. Such methods include, based on receiving from the RAN a handover command to a target cell, determining whether time elapsed from the supervision timer exceeds the supervision timer threshold included in the SHR configuration and transmitting a successful handover report to the RAN based on determining that the time elapsed exceeds the supervision timer threshold.

### TECHNICAL FIELD

The present disclosure relates generally to wireless networks, and more specifically to techniques for a network to configure user equipment (UEs) to provide reports about successful handovers in the network, and for UEs to manage and use such configurations.

### BACKGROUND

Long-Term Evolution (LTE) is an umbrella term for so-called fourth generation (4G) radio access technologies developed within the Third-Generation Partnership Project (3GPP) and initially standardized in Release 8 (Rel-8) and Release 9 (Rel-9), also known as Evolved UTRAN (E-UTRAN). LTE is targeted at various licensed frequency bands and is accompanied by improvements to non-radio aspects commonly referred to as System Architecture Evolution (SAE), which includes Evolved Packet Core (EPC) network. LTE continues to evolve through subsequent releases.

Currently the fifth generation (“5G”) of cellular systems, also referred to as New Radio (NR), is being standardized within 3GPP. NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates an exemplary high-level view of a 5G network architecture, including a Next Generation RAN (NG-RAN) 199 and a 5G Core (5GC) 198. NG-RAN 199 can include a set of gNodeB's (gNBs) connected to the 5GC via one or more NG interfaces, such as gNBs 100, 150 connected via interfaces 102, 152, respectively. In addition, the gNBs can be connected to each other via one or more Xn interfaces, such as Xn interface 140 between gNBs 100 and 150. With respect the NR interface to UEs, each of the gNBs can support frequency division duplexing (FDD), time division duplexing (TDD), or a combination thereof.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a central (or centralized) unit (CU or gNB-CU) and one or more distributed (or decentralized) units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUs and DUs can include various circuitry needed to perform their respective functions, including processing circuitry, transceiver circuitry (e.g., for communication), and power supply circuitry.

A gNB-CU connects to gNB-DUs over respective F1 logical interfaces, such as interfaces 122 and 132 shown in FIG. 1. The gNB-CU and connected gNB-DUs are only visible to other gNBs and the 5GC as a gNB. In other words, the F1 interface is not visible beyond gNB-CU.

Seamless handovers are a key feature of 3GPP technologies. A UE is handed over from a source or serving cell, provided by a source node, to a target cell provided by a target node. Successful handovers ensure that the UE moves around in the coverage area of different cells without causing too many interruptions in the data transmission.

However, handover can have various problems related to robustness. For example, a handover command (e.g., RRCConnectionReconfiguration with mobilityControlInfo or RRCReconfiguration with a reconfigurationWithSync) is normally sent when the radio conditions for the UE are already quite bad and may not reach the UE before the UE's degraded connection with the source node/cell is dropped. This causes the UE to declare radio link failure (RLF) or handover failure (HOF). Similarly, the UE may experience failure when trying to reestablish a failed connection with the network, causing the UE to declare connection establishment failure (CEF).

Various UE failure reporting procedures were introduced as part of the mobility robustness optimization (MRO) in LTE Rel-9. In these procedures, UEs log relevant information at the time of failure (e.g., RLF) and later report such information to the network via target cells to which UEs ultimately connect (e.g., after reestablishment). The reported information can include radio resource management (RRM) measurements of various neighbor cells prior to the mobility operation (e.g., handover).

3GPP is also specifying (e.g., in Rel-17) a successful handover report (SHR, also referred to as handover success report) that will be sent by UE to network upon successful execution of a handover command. For example, 3GPP has defined an SHR configuration that a UE applies when it in an RRC_CONNECTED state to report information (e.g., measurements) related to a successful handover under some specific conditions that are configured by the network.

One possible condition is related to a timer T312, specifically a threshold value (e.g., thresholdPercentageT312) that indicates a percentage of the elapsed time to the configured maximum time for the T312 timer. Once the HO is executed, the UE starts checking if the timer T312 value is above the configured thresholdPercentageT312. The UE generates a SHR when the timer T312 value exceeds thresholdPercentageT312.

### SUMMARY

However, there are various problems, issues, and/or difficulties related to SHR configurations. For example, the network can configure a UE with multiple reporting configurations and link these reporting configurations to different measurement objects via different measurement identifiers (measIDs). As such, it is possible that a UE has more than one reporting configuration in which the T312-related condition has been enabled and/or set. This can cause various ambiguities in how the network interprets a SHR received from the UE.

Embodiments of the present disclosure provide specific improvements to successful handover reporting by UEs in a wireless network, such as by providing, enabling, and/or facilitating solutions to exemplary problems summarized above and described in more detail below.

Embodiments include methods (e.g., procedures) for providing successful handover reports to a RAN. These exemplary methods can be performed by a UE.

These exemplary methods can include receiving, from the RAN, a configuration for SHR by the UE. The SHR configuration includes a single supervision timer threshold that is associated with all measurement objects configured for the UE. These exemplary methods can also include, upon transmitting to the RAN a measurement report associated with a first one of the measurement objects, initiating a supervision timer (e.g., T312) based on an initial time value associated with the first measurement object. These exemplary methods can also include, based on receiving from the RAN a handover command to a target cell, determining whether time elapsed from the supervision timer exceeds the supervision timer threshold included in the SHR configuration. These exemplary methods can also include transmitting a successful handover report to the RAN based on determining that the time elapsed exceeds the supervision timer threshold.

In some embodiments, the supervision timer threshold indicates a percentage of an initial time value used to initiate the supervision timer. In such case, determining whether the time elapsed from the supervision timer exceeds the supervision timer threshold can include comparing the supervision timer threshold against the time elapsed as a percentage of the initial time value used to initiate the supervision timer. In some embodiments, the supervision timer is T312 and the supervision timer threshold is thresholdPercentageT312.

In some embodiments, the UE is configured with a plurality of measurement objects and with each measurement object identifies or is associated with the following: an initial time value for the supervision timer, and one or more frequencies of signals to be measured. In some of these embodiments, these exemplary methods can also include, upon receiving the handover command, determining whether the target cell is associated with at least one frequency identified by the first measurement object, for which the supervision timer was initiated. In such embodiments, determining whether time elapsed from the supervision timer exceeds the supervision timer threshold is based on determining that the target cell is associated with at least one frequency identified by the first measurement object.

In various embodiments, the successful handover report can include one or more of the following:
a measurement object identifier associated with measurements that triggered the measurement report;
identifiers of one or more measurements that triggered the measurement report;
an identifier of a reporting configuration associated with a measurement identifier that is associated with the measurements that triggered the measurement report;
a channel number on which the measurements that triggered the measurement report were made; and
the initial time value used when initiating the supervision timer.

In some of these embodiments, the successful handover report can also include one or more of the following:
values of one or more other timers or counters that triggered the measurement report;
type of signal on which the measurements that triggered the measurement report were made; and
frequency information related to one or more further measurement reports that were triggered while the supervision timer was running.

Other embodiments include methods (e.g., procedures) for receiving successful handover reports from a UE. These exemplary methods can be performed by one or more RAN nodes and are generally complementary to the exemplary methods summarized above.

These exemplary methods can include sending, to the UE, a configuration for SHR by the UE. The SHR configuration includes a single supervision timer threshold that is associated with all measurement objects configured for the UE. These exemplary methods can also include subsequently receiving a successful handover report from the UE when time elapsed on a UE supervision timer (e.g., T312) exceeds the supervision timer threshold included in the SHR configuration.

In some embodiments, the supervision timer threshold indicates a percentage of an initial time value used to initiate the supervision timer, the successful handover report is received when the time elapsed from the UE supervision timer, as a percentage of the initial time value used to initiate the supervision timer, exceeds the supervision timer threshold. In some embodiments, the supervision timer is T312 and the supervision timer threshold is thresholdPercentageT312.

In some embodiments, these exemplary methods can also include configuring the UE with a plurality of measurement objects. Each measurement object identifies or is associated with the following: one or more frequencies of signals to be measured, and an initial time value for the supervision timer.

In some embodiments, these exemplary methods can also include receiving a measurement report from the UE and based on the measurement report, sending to the UE a handover command to a target cell. In such case, the successful handover report is received responsive to the handover command. In some of these embodiments, the measurement report is associated with a first measurement object configured for the UE and the successful handover report is received when the target cell is associated with at least one frequency identified by the first measurement object.

In various embodiments, the successful handover report can include any of the information summarized above in relation to the UE embodiments.

Other embodiments include UEs (e.g., wireless devices, etc.) and RAN nodes (e.g., base stations, eNBs, gNBs, ng-eNBs, TRPs, etc.) configured to perform operations corresponding to any of the exemplary methods described herein. Other embodiments include non-transitory, computer-readable media storing program instructions that, when executed by processing circuitry, configure such UEs or RAN nodes to perform operations corresponding to any of the exemplary methods described herein.

Generally, these and other embodiments described herein provide useful SHR information that facilitates network operational improvements that can benefit UEs performing subsequent handovers. As a more specific example, embodiments facilitate more detailed UE reporting of successful handovers, which enables the network to know which frequency-related measurements satisfied the T312-related triggering condition for the SHR. This enables the network to better optimize T312 configurations related to that frequency, thereby improving mobility robustness for UEs operating in the network.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate two high-level views of an exemplary 5G/NR network architecture.

FIG. 3 shows an exemplary configuration of NR user plane (UP) and control plane (CP) protocol stacks.

FIGS. 4A-B illustrate some reasons why handover of a UE may be unsuccessful.

FIG. 5 illustrates 3GPP self-organizing network (SON) functionality.

FIGS. 6-7 illustrate various aspects of UE's operation during an exemplary radio link failure (RLF) procedure in LTE and NR.

FIGS. 8-12 show various exemplary ASN.1 data structures for a SuccessHO-Config-r17 information element (IE), according to various embodiments of the present disclosure.

FIGS. 13-16 show various exemplary ASN.1 data structures for a SuccessHO-Report-r17 E, according to various embodiments of the present disclosure.

FIG. 17 shows a flow diagram of an exemplary method (e.g., procedure) for a UE, according to various embodiments of the present disclosure.

FIG. 18 shows a flow diagram of an exemplary method (e.g., procedure) for a RAN node (e.g., base station, eNB, gNB, ng-eNB, etc.), according to various embodiments of the present disclosure.

FIG. 19 shows a communication system according to various embodiments of the present disclosure.

FIG. 20 shows a UE according to various embodiments of the present disclosure.

FIG. 21 shows a network node according to various embodiments of the present disclosure.

FIG. 22 shows host computing system according to various embodiments of the present disclosure.

FIG. 23 is a block diagram of a virtualization environment in which functions implemented by some embodiments of the present disclosure may be virtualized.

FIG. 24 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the enclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Base station: As used herein, a “base station” may comprise a physical or a logical node transmitting or controlling the transmission of radio signals, e.g., eNB, gNB, ng-eNB, en-gNB, centralized unit (CU)/distributed unit (DU), transmitting radio network node, transmission point (TP), transmission reception point (TRP), remote radio head (RRH), remote radio unit (RRU), Distributed Antenna System (DAS), relay, etc.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

FIG. 2 shows a high-level view of an exemplary 5G network architecture, including an NG-RAN 299 and a 5GC 298. As shown in the figure, NG-RAN 299 can include gNBs (e.g., 210a,b) and ng-eNBs (e.g., 220a,b) that are interconnected with each other via respective Xn interfaces. The gNBs and ng-eNBs are also connected via the NG interfaces to the 5GC, more specifically to the access and mobility management functions (AMFs, e.g., 230a,b) via respective NG-C interfaces and to user plane functions (UPFs, e.g., 240a,b) via respective NG-U interfaces. Moreover, the AMFs can communicate with one or more policy control functions (PCFs, e.g., 250a,b) and network exposure functions (NEFs, e.g., 260a,b).

Each of the gNBs can support the NR radio interface including frequency division duplexing (FDD), time division duplexing (TDD), or a combination thereof. Each of ng-eNBs can support the LTE radio interface. Unlike conventional LTE eNBs, however, ng-eNBs 220 connect to the 5GC via the NG interface. Each of the gNBs and ng-eNBs can serve a geographic coverage area including one more cells, such as cells 211a-b and 221a-b shown in FIG. 2. Depending on the cell in which it is located, a UE 205 can communicate with the gNB or ng-eNB serving that cell via the NR or LTE radio interface, respectively. Although FIG. 2 shows gNBs and ng-eNBs separately, it is also possible that a single NG-RAN node provides both types of functionality.

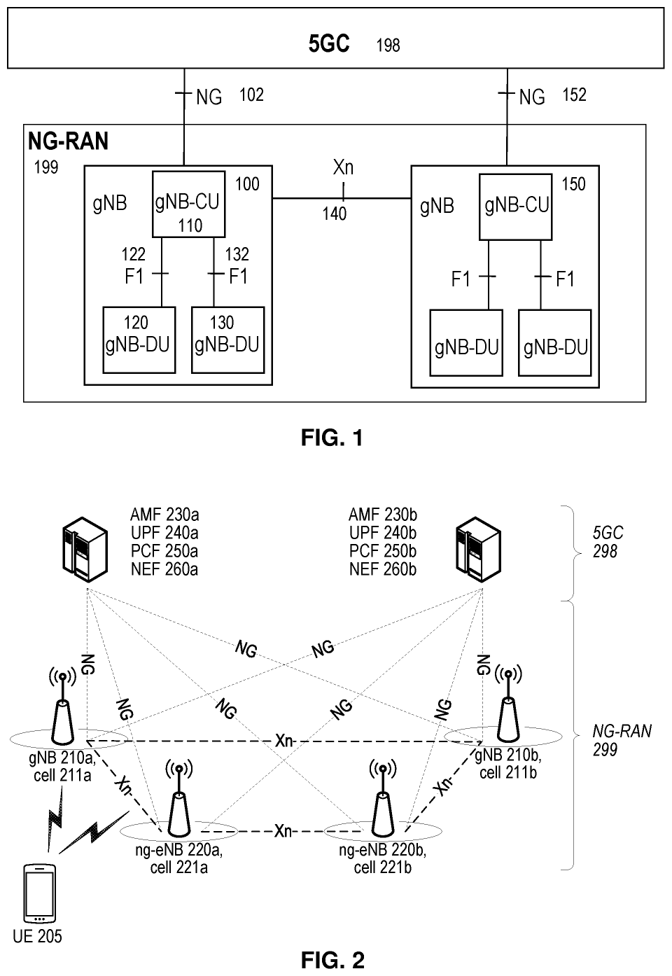

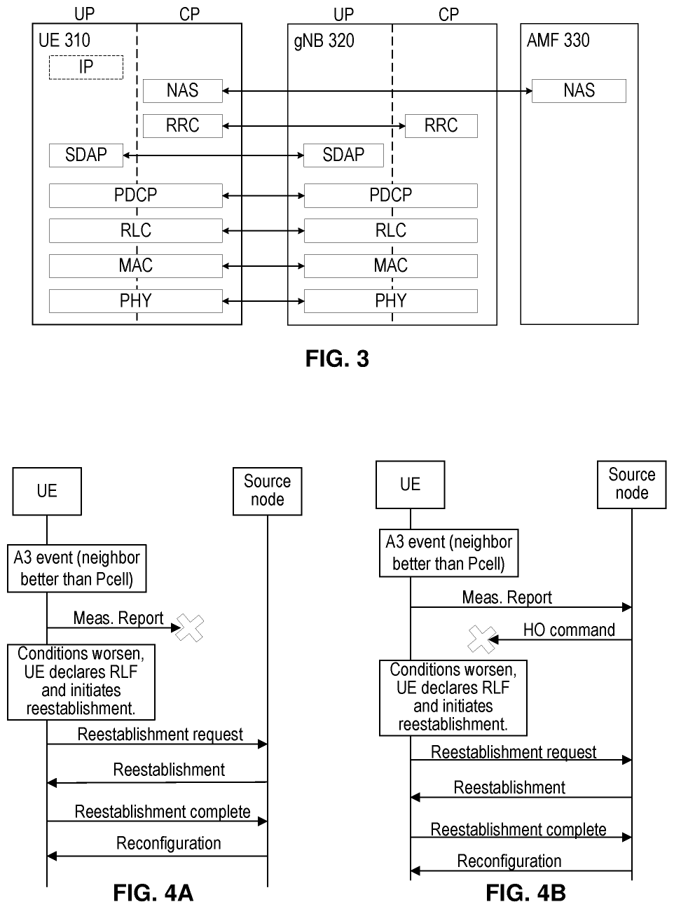

FIG. 3 shows an exemplary configuration of NR user plane (UP) and control plane (CP) protocol stacks between a UE (310), a gNB (320), and an AMF (330), such as those shown in FIGS. 1-2. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. The RLC layer transfers PDCP PDUs to the MAC through logical channels (LCH). RLC provides error detection/correction, concatenation, segmentation/reassembly, sequence numbering, reordering of data transferred to/from the upper layers. The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

LTE Rel-12 introduced dual connectivity (DC) whereby a UE in RRC_CONNECTED state can be connected to two network nodes simultaneously, thereby improving connection robustness and/or capacity. In LTE DC, these two network nodes are referred to as “Master eNB” (MeNB) and “Secondary eNB” (SeNB), or more generally as master node (MN) and secondary node (SN). More specifically, a UE is configured with a Master Cell Group (MCG) associated with the MN and a Secondary Cell Group (SCG) associated with the SN.

Each of these groups of serving cells include one MAC entity, a set of logical channels with associated RLC entities, a primary cell (PCell or PSCell), and optionally one or more secondary cells (SCells). The term “Special Cell” (or “SpCell” for short) refers to the PCell of the MCG or the PSCell of the SCG depending on whether the UE's MAC entity is associated with the MCG or the SCG, respectively. In non-DC operation (e.g., CA), SpCell refers to the PCell. An SpCell is always activated and supports physical uplink control channel (PUCCH) transmission and contention-based random access (CBRA) by UEs.

The MeNB provides system information (SI) and terminates the control plane connection towards the UE and, as such, is the controlling node of the UE, including handovers to and from SeNBs. For example, the MeNB terminates the connection between the eNB and the MME for the UE. An SeNB provides additional radio resources (e.g., bearers) for radio resource bearers include MCG bearers, SCG bearers, and split bearers that have resources from both MCG and SCG. The reconfiguration, addition, and removal of SCells can be performed by RRC. When adding a new SCell, dedicated RRC signaling is used to send the UE all required SI of the SCell, such that UEs need not acquire SI directly from the SCell broadcast. In addition, either or both of the MCG and the SCG can include multiple cells working in carrier aggregation (CA). 3GPP TR 38.804 (v14.0.0) describes various exemplary DC scenarios or configurations in which the MN and SN can apply NR, LTE, or both. The following terminology is used to describe these exemplary DC scenarios or configurations:
DC: LTE DC (i.e., both MN and SN employ LTE, as discussed above);
EN-DC: LTE-NR DC where MN (eNB) employs LTE and SN (gNB) employs NR, and both are connected to EPC.
NGEN-DC: LTE-NR dual connectivity where a UE is connected to one ng-eNB that acts as a MN and one gNB that acts as a SN. The ng-eNB is connected to the 5GC and the gNB is connected to the ng-eNB via the Xn interface.
NE-DC: LTE-NR dual connectivity where a UE is connected to one gNB that acts as a MN and one ng-eNB that acts as a SN. The gNB is connected to 5GC and the ng-eNB is connected to the gNB via the Xn interface.
NR-DC (or NR-NR DC): both MN and SN employ NR.
MR-DC (multi-RAT DC): a generalization of the Intra-E-UTRA Dual Connectivity (DC) described in 3GPP TS 36.300 (v16.3.0), where a multiple Rx/Tx UE may be configured to utilize resources provided by two different nodes connected via non-ideal backhaul, one providing E-UTRA access and the other one providing NR access. One node acts as the MN and the other as the SN. The MN and SN are connected via a network interface and at least the MN is connected to the core network. EN-DC, NE-DC, and NGEN-DC are different example cases of MR-DC.

Seamless mobility is a key feature of 3GPP radio access technologies (RATs). In general, a network configures a UE to perform and report RRM measurements to assist network-controlled mobility decisions, such as for handover from a serving cell to a neighbor cell while the UE is in RRC_CONNECTED state. Seamless handovers ensure that the UE moves around in the coverage area of different cells without causing too many interruptions in data transmission.

During preparation for handover of a UE to a target node, the source node sends the current UE configuration to the target node in the HANDOVER REQUEST message. The target node prepares a target configuration for the UE based on the current configuration and the capabilities of the target node and the UE. The target node sends the target configuration to the source node in a HANDOVER REQUEST ACKNOWLEDGE message, which the source node encapsulates in an RRCReconfiguration message to the UE. As a streamlined option, the target configuration can be signaled as a “delta-configuration” including only the differences from the UE's current configuration in the source cell.

Handovers are normally triggered when the UE is at the edge of a cell's coverage and experiences poor radio conditions. Once the UE experiences such conditions, the network may be unable to receive a measurement report from the UE, such that the network will not initiate a handover procedure. Even if the network does receive measurement reports, the UE may be unable to receive the network's handover command (i.e., the RRCReconfiguration message with a reconfigurationWithSync field) due to poor DL radio conditions. Moreover, in poor radio conditions the DL message is often segmented, which increases the likelihood of retransmissions with associated delay. As such, even if the handover command reaches the UE, it may be too late. For these reasons, failed transmission of handover command is a common reason for unsuccessful handovers.

FIG. 4, which includes FIGS. 4A and 4B, illustrates various exemplary robustness problems that can occur during UE mobility operations, such as during a handover. In the scenario shown in FIG. 4A, based on neighbor-cell measurements, the UE triggers an “A3 event” where the neighbor cell is better than the UE's primary cell (PCell). In response, the UE attempts to send a measurement report about this condition to the source (e.g., serving) node. Due to the rapidly degrading uplink radio conditions, however, the source node does not receive the measurement report from the UE. Conditions continue to degrade in the UE's source cell, ultimately prompting the UE to declare RLF and attempt to reestablish a connection with the source node (which may or may not be successful). In FIG. 4B, the source node correctly receives the UE's measurement report but due to degrading downlink radio conditions, the UE does not receive the HO command from the source node. Ultimately, the same result occurs in both cases shown in FIG. 4.

As such, there is a need to improve mobility robustness in NR systems, and 3GPP Rel-16 includes some features called mobility robustness optimization (MRO). The main objectives of MRO are to improve the robustness at handover and to decrease the interruption time at handover. One solution is called “conditional handover” (or “CHO” for short) or “early handover command.” In CHO, transmission and execution of the handover command are separated. This allows the handover command to be sent earlier to UE when the radio conditions are still good, thus increasing the likelihood that the message is successfully transferred. The execution of the handover command is done at later point in time based on an associated execution condition. The execution condition is typically in the form a threshold, e.g., signal strength of candidate target cell becomes X dB better than the serving cell (so-called A3 event) or signal strength of serving cell becomes worse than X dBm and signal strength of candidate target cell becomes better than Y dBm (so-called A5 event).

A preceding measurement reporting event could use a threshold Y that is selected to be lower than the one in the handover execution condition. This allows the serving cell to prepare the handover upon reception of an early measurement report and to provide the RRCConnectionReconfiguration with mobilityControlInfo (for LTE), or a RRCReconfiguration with either a reconfigurationWithSync or a CellGroupConfig (for NR) at a time when the radio link between the source cell and the UE is still relatively stable. The execution of the handover is done at a later point in time (and threshold) that is optimal and/or preferred for handover execution.

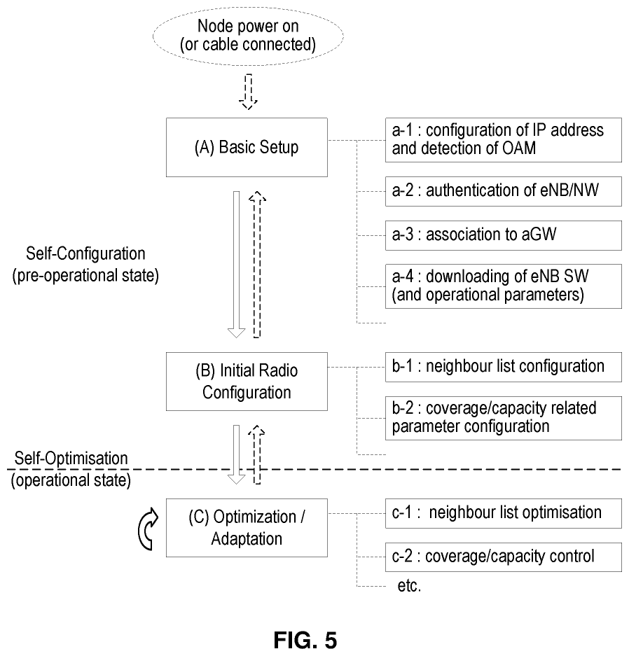

Self-Organizing Network (SON) functionality is intended to make planning, configuration, management, optimization, and healing of mobile RANs simpler and faster. SON functionality and behavior has been defined and specified in by organizations such as 3GPP and NGMN (Next Generation Mobile Networks). FIG. 5 is a high-level diagram illustrating 3GPP's division of SON functionality into a self-configuration process and a self-optimization process.

Self-configuration is a pre-operational process in which newly deployed nodes (e.g., eNBs or gNBs in a pre-operational state) are configured by automatic installation procedures to get the necessary basic configuration for system operation. Pre-operational state generally refers to the time when the node is powered up and has backbone connectivity until the node's RF transmitter is switched on. Self-configuration operations in pre-operational state include (A) basic setup and (B) initial radio configuration, and each includes various sub-operations as shown in FIG. 5.

Self-optimization is a process in which UE and network measurements are used to auto-tune the network. This occurs when the nodes are in an operational state, which generally refers to the time when the node's RF transmitter interface switched on. Self-configuration operations include optimization and adaptation, which include various sub-operations as shown in FIG. 5.

Self-configuration and self-optimization features for LTE networks are described in 3GPP TS 36.300 (v) section 22.2. These include dynamic configuration, automatic neighbor relations (ANR), mobility load balancing (MLB), mobility robustness optimization (MRO), RACH optimization, and support for energy savings. Self-configuration and self-optimization features for NR networks are described in 3GPP TS 38.300 section 15. Rel-15 features include dynamic configuration and ANR, with additional features such as MRO being specified for Rel-16.

Returning to discussion of RLF, a network can configure a UE in RRC_CONNECTED state to perform and report RRM measurements that assist network-controlled mobility decisions such as UE handover between cells, SN change, etc. The UE may lose coverage in its current serving cell (e.g., PCell in DC) and attempt handover to a target cell. Similarly, a UE in DC may lose coverage in its current PSCell and attempt an SN change. Other events may trigger other mobility-related procedures.

An RLF procedure is typically triggered in the UE when something unexpected happens in any of these mobility-related procedures. The RLF procedure involves interactions between RRC and lower layer protocols such as PHY (or L1), MAC, RLC, etc. including radio link monitoring (RLM) on L1.

The principle of RLM is similar in LTE and NR. In general, the UE monitors link quality of the UE's serving cell (i.e., SpCell) and uses that information to decide whether the UE is in-sync (IS) or out-of-sync (OOS) with respect to that serving cell. In LTE, RLM is carried out by the UE measuring downlink reference signals (e.g., CRS) in RRC_CONNECTED state. If RLM (i.e., by L1/PHY) indicates number of consecutive OOS conditions to the UE RRC layer, then RRC starts a radio link failure (RLF) procedure and declares RLF after expiry of a timer (e.g., T310). The L1 RLM procedure is carried out by comparing the estimated CRS measurements to some target block error rates (BLERs), called Qout and Qin. In particular, Qout and Qin correspond to BLER of hypothetical PDCCH/PCIFCH transmissions from the serving cell, with exemplary values of 10% and 2%, respectively. In NR, the network can define the RS type (e.g., CSI-RS and/or SSB), exact resources to be monitored, and even the BLER target for IS and OOS indications.

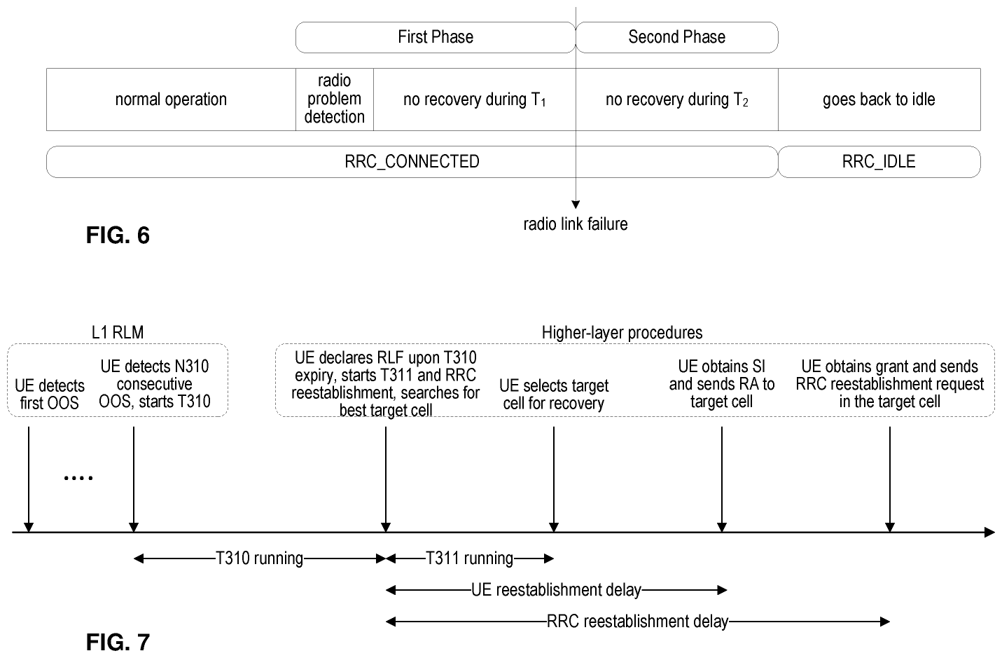

FIG. 6 shows a high-level timing diagram illustrating the two phases of an RLF procedure in LTE and NR. The first phase starts upon radio problem detection and leads to radio link failure detection after no recovery is made during a period T1. The second phase starts upon RLF detection or handover failure and ends with the UE returning to RRC_IDLE if no recovery is made during a period T2.

FIG. 7 shows a more detailed version of the UE's operations during an exemplary RLF procedure, such as for LTE or NR. In this example, the UE detects N310 consecutive OOS conditions during L1 RLM procedures, as discussed above, and then initiates timer T310. Subsequent operations are performed by higher layers (e.g., RRC). After expiry of T310, the UE starts T311 and RRC reestablishment, searching for the best target cell. After selecting a target cell for reestablishment, the UE obtains system information (SI) for the target cell and performs a random access (e.g., via RACH). The duration after T310 expiry until this point can be considered the UE's reestablishment delay. Ultimately, the UE obtains access to the target cell and sends an RRC Reestablishment Request message to the target cell. The duration after T310 expiry until this point can be considered the total RRC reestablishment delay. If the UE does not successfully reestablish in a target cell before expiration of T311, the UE enters RRC_IDLE and releases its connection to the network.

The timers and counters described above are further described in Tables 1-2 below, respectively. For NR-DC and NGEN-DC, T310 is used for both PCell/MCG and PSCell/SCG. For LTE-DC and NE-DC (i.e., where SN is eNB), T313 is used for PSCell/SCG. The UE reads the timer values from system information (SI) broadcast in the UE's SpCell. Alternatively, the network can configure the UE with UE-specific values of the timers and constants via dedicated RRC signaling (i.e., specific values sent to specific UEs via respective messages).

TABLE 1

| Timer | Start | Stop | At expiry |
|---|---|---|---|
| T310 | Upon detecting | Upon receiving N311 | If the T310 is kept in |
| | physical layer | consecutive in-sync indications | MCG: If AS security is |
| | problems for the | from lower layers for the SpCell, | not activated: go to |
| | SpCell i.e., upon | upon receiving | RRCIDLE else: initiate |
| | receiving N310 | RRCReconfiguration with | the connection re- |
| | consecutive out- | reconfigurationWithSync for that | establishment procedure. |
| | of-sync | cell group, and upon initiating | If the T310 is kept in |
| | indications from | the connection re-establishment | SCG, Inform E- |
| | lower layers. | procedure. Upon SCG release, if | UTRAN/NR about the |
| | | the T310 is kept in SCG. | SCG radio link failure by |
| | | | initiating the SCG failure |
| | | | information procedure as |
| | | | specified in 5.7.3. |
| T311 | Upon initiating | Upon selection of a suitable NR | Enter RRC_IDLE |
| | the RRC | cell or a cell using another RAT. | |
| | connection re- | | |
| | establishment | | |
| | procedure | | |
| T313 | Upon detecting | Upon receiving N314 | Inform E-UTRAN about |
| | physical layer | consecutive in-sync indications | the SCG radio link |
| | problems for the | from lower layers for the PSCell, | failure by initiating the |
| | PSCell i.e., upon | upon initiating the connection re- | SCG failure information |
| | receiving N313 | establishment procedure, upon | procedure as specified in |
| | consecutive out- | SCG release and upon receiving | 5.6.13. |
| | of-sync | RRCConnectionReconfiguration | |
| | indications from | including | |
| | lower layers | MobilityControlInfoSCG | |

TABLE 2

| Constant | Usage |
|---|---|
| N310 | Maximum number of consecutive “out-of-sync” |
| | indications for the SpCell received from lower layers |
| N311 | Maximum number of consecutive “in-sync” |
| | indications for the SpCell received from lower layers |
| N313 | Maximum number of consecutive “out-of-sync” |
| | indications for the PSCell received from lower layers |
| | (for LTE SN) |

One reason for introducing the timers and counters listed above is to add some filtering, delay, and/or hysteresis to a UE's determination of failure and/or recovery of a radio link with a serving cell. These parameters avoid a UE abandoning a connection prematurely due to a brief or temporary reduction in link quality that could be recovered by the UE (e.g., before T310 expires, before the counter value N310, etc.). In general, this improves user experience. In contrast to RLF described above, a UE declares handover failure (HOF) upon expiry of timer T304 while performing the handover to the target cell.

In case of HOF or RLF, the UE may take autonomous actions to remain reachable by the network, such as selecting a cell and initiating reestablishment. In general, a UE declares RLF only when the UE realizes that there is no reliable communication channel (or radio link) available between itself and the network, which can result in poor user experience. Also, reestablishing the connection requires signaling with a newly selected cell (e.g., random access procedure, exchanging various RRC messages, etc.), introducing latency until the UE can again reliably transmit and/or receive user data with the network. According to 3GPP TS 36.331 (v15.7.0), the possible causes for RLF include:
1) Radio link problem indicated by PHY (e.g., expiry of RLM-related timer T310);
2) Random access problem indicated by MAC entity;
3) Expiry of a measurement reporting timer (e.g., T312), due to not receiving a HO command from the network while the timer is running despite sending a measurement report; and
4) Reaching a maximum number of RLC retransmissions.

Since RLF leads to reestablishment in a new cell and degradation of UE/network performance and end-user experience, it is in the interest of the network to understand the reasons for UE RLF and to optimize mobility-related parameters (e.g., trigger conditions of measurement reports) to reduce, minimize, and/or avoid subsequent RLFs. Before Rel-9 mobility robustness optimizations (MRO), only the UE was aware of radio quality at the time of RLF, the actual reason for declaring RLF, etc. To identify the RLF cause, the network requires more information from the UE and from the neighboring base stations (e.g., eNBs).

An RLF reporting procedure was introduced as part of MRO for NR Rel-16. In this procedure, a UE logs relevant information at the time of RLF and later reports such information to the network via a target cell to which the UE ultimately connects (e.g., after reestablishment). The UE can store the RLF report in a UE variable call varRLF-Report and retains it in memory for up to 48 hours, after which it may discard the information.

When sending certain RRC messages such as RRCReconfigurationComplete, RRCReestablishmentComplete, RRCSetup-Complete, and RRCResumeComplete, the UE can indicate it has a stored RLF report by setting a rlf-InfoAvailable field to “true”. If the gNB serving the target cell wants to receive the RLF report, it sends the UE an UEInformationRequest message with a flag “rlf-ReportReq-r16”. In response, the UE sends the gNB an UEInformationResponse message that includes the RLF report.

In general, the UE-reported RLF information can include any of the following:
Measurement quantities (RSRP, RSRQ) of the last serving cell (PCell).
Measurement quantities of the neighbor cells in different frequencies of different RATs (e.g., EUTRA, UTRA, GERAN, CDMA2000).
Measurement quantity (RSSI) associated to WLAN APs.
Measurement quantity (RSSI) associated to Bluetooth beacons.
Location information, if available (including location coordinates and velocity)
Globally unique identity of the last serving cell, if available, otherwise the PCI and the carrier frequency of the last serving cell.
Tracking area code of the PCell.
Time elapsed since the last reception of the ‘Handover command’ message.
Cell Radio Network Temporary Identifier (C-RNTI) used in the previous serving cell.
Whether or not the UE was configured with a data radio bearer (DRB) having QCI=1.

The RLF reporting procedure not only introduced new RRC signaling between UE and the network (e.g., a target gNB hosting the target cell), but also introduced signaling between nodes in the network (e.g., XnAP signaling specified in 3GPP TS 38.423). For example, a gNB receiving an RLF report could forward some or all of the report to the gNB in which the RLF originated. Two different types of inter-node messages have been standardized in in 3GPP TS 38.423 for sending RLF reports between nodes: Failure indication and Handover report.

Based on the contents of the RLF report (e.g., a globally unique identity of the last serving cell), the node serving the target cell (i.e., the UE's new serving cell) can determine the cell where the RLF originated and forward the RLF report to the source gNB serving that cell. Based on receiving this report, the node serving the UE's source cell (i.e., where the RLF occurred) can deduce whether the RLF was caused due to a coverage hole or due to handover-related parameter configurations. If the RLF was deemed to be due to handover associated parameter configurations, the original serving cell can further classify the handover related failure as too-early, too-late, or handover to wrong cell classes.

The original serving cell can classify a handover failure to be ‘too late handover’ when the original serving cell fails to send the handover command to the UE associated to a handover towards a particular target cell and if the UE reestablishes itself in this target cell post RLF. An example corrective action from the original serving cell could be to initiate the handover procedure towards this target cell a bit earlier by decreasing the CIO (cell individual offset) towards the target cell that controls when the IE sends the event triggered measurement report that leads to taking the handover decision.

The original serving cell can classify a handover failure to be ‘too early handover’ when the original serving cell is successful in sending the handover command to the UE associated to a handover however the UE fails to perform the random access towards this target cell. An example corrective action from the original serving cell could be to initiate the handover procedure towards this target cell a bit later by increasing the CIO (cell individual offset) towards the target cell that controls when the IE sends the event triggered measurement report that leads to taking the handover decision.

The original serving cell can classify a handover failure to be ‘handover-to-wrong-cell’ when the original serving cell intends to perform the handover for this UE towards a particular target cell, but the UE declares the RLF and reestablishes itself in a third cell. A corrective action from the original serving cell could be to initiate the measurement reporting procedure that leads to handover towards the target cell a bit later by decreasing the CIO (cell individual offset) towards the target cell or via initiating the handover towards the cell in which the UE reestablished a bit earlier by increasing the CIO towards the reestablishment cell.

The concept of a successful handover report (SHR) was described in the 3GPP TR 37.816 (v16.0.0). In general, this concept involves the UE sending additional information to the target cell upon successfully completing a handover. In this way, additional knowledge available at the UE about the radio conditions, failure possibilities, etc. can be provided to the network, which can facilitate tuning handover parameters. Relevant portions of 3GPP TR 37.816 are given below.

***Begin Text from 3GPP TR 37.816***

### 5.3.2.5 Successful HO Report

The MRO function in NR could be enhanced to provide a more robust mobility via reporting failure events observed during successful handovers. A solution to this problem is to configure the UE to compile a report associated to a successful handover comprising a set of measurements collected during the handover phase, i.e., measurement at the handover trigger, measurement at the end of handover execution or measurement after handover execution. The UE could be configured with triggering conditions to compile the Successful Handover Report; hence the report would be triggered only if the conditions are met. This limits UE reporting to relevant cases, such as underlying issues detected by RLM, or BFD detected upon a successful handover event.

The availability of a Successful Handover Report may be indicated by the Handover Complete message (RRCReconfigurationComplete) transmitted from UE to target NG-RAN node over RRC. The target NG-RAN node may fetch information of a successful handover report via UE Information Request/Response mechanism. In addition, the target NG-RAN node could then forward the Successful Handover Report to the source NR-RAN node to indicate failures experienced during a successful handover event.

The information contained in the successful handover report may comprise:
RLM related information
RLM related timers (e.g., T310, T312)
Measurements of reference signals used for RLM in terms of RSRP, RSRQ, SINR
RLC retransmission counter
Beam failure detection (BFD) related information
   Detection indicators and counters (e.g., Qin and Qout indications)
   Measurements of reference signals used in BFD in terms of RSRP, RSRQ, SINR
Handover related information
   Measurements of the configured reference signals at the time of successful handover
      SSB beam measurements
      CSI-RS measurements
   Handover related timers (e.g., T304)
   Measurement period indication, i.e., measurements are collected at handover trigger, at the end of handover execution or just after handover execution

Upon reception of a Successful HO Report, the receiving node is able to analyze whether its mobility configuration needs adjustment. Such adjustments may result in changes of mobility configurations, such as changes of RLM configurations or changes of mobility thresholds between the source and the target. In addition, target NG RAN node, in the performed handover, may further optimize the dedicated RACH-beam resources based on the beam measurements reported upon successful handovers.

***End Text from 3GPP TR 37.816***

UE timer T312 is initiated upon transmission of a measurement report associated with a measurement identity (measID) for which the timer T312 is configured and enabled by the network. Once initiated, the UE stops T312 when certain conditions are fulfilled, such as upon receiving N311 consecutive in-sync indications from lower layers for the SpCell or upon receiving/executing a HO command. Otherwise, when T312 expires the UE initiates a reestablishment procedure or transmits an MCG failure information or SCG failure information depending on whether the T312 expired for the MCG or SCG.

More specifically, T312 is initiated in the MCG upon triggering a measurement report for a measurement identity for which T312 has been configured and useT312 has been set to true, while T310 in PCell is running. Likewise, T312 is initiated in the SCG upon triggering a measurement report for a measurement identity for which T312 has been configured and useT312 has been set to true, while T310 in PSCell is running. T312 is stopped upon any of the following conditions:
receiving N311 consecutive in-sync indications from lower layers for the SpCell,
receiving RRCReconfiguration with reconfigurationWithSync for that cell group,
reception of MobilityFromNRCommand,
initiating the connection re-establishment procedure,
reconfiguration of rlf-TimersAndConstant,
initiating the MCG failure information procedure,
conditional reconfiguration execution, i.e., when applying a stored RRCReconfiguration message including reconfigurationWithSync for that cell group,
expiry of T310 in corresponding SpCell, and
SCG release, if T312 is kept in SCG.

Upon expiration of T312 kept in MCG, the UE initiates an MCG failure information procedure as specified in 3GPP TS 38.331 (v16.7.0) section 5.7.3b or the connection re-establishment procedure. Upon expiration of T312 kept in SCG, the UE Informs E-UTRAN/NR about the SCG RLF by initiating the SCG failure information procedure. as specified in 3GPP TS 38.331 (v16.7.0) section 5.7.3.

The network can configure a UE with multiple reporting configurations and link these reporting configurations to different measurement objects via different measurement identifiers (measIDs). As such, it is possible that a UE has more than one reporting configuration in which the T312-related condition has been enabled and/or set.

One condition that triggers SHR is also related to T312, specifically a threshold value (e.g., thresholdPercentageT312) that indicates a percentage of the elapsed time to the configured maximum time for T312. Once the HO is executed, the UE starts checking whether the T312 value is above the configured thresholdPercentageT312. The UE generate a SHR when the T312 value exceeds thresholdPercentageT312.

When a UE is configured with multiple measID-linked reporting configurations in which T312 has been enabled and also with a thresholdPercentageT312 triggering condition for SHR, the network is currently unable to determine which of the configured T312-related conditions triggered SHR by the UE. For example, it is unclear whether SHR is triggered by T312 associated with a measID-linked reporting configuration for the target cell related frequency or by T312 associated with a reporting configurations associated for frequencies of cells other than the target. This can cause various ambiguities in how the network interprets a SHR received from the UE.

Accordingly, embodiments of the present disclosure provide flexible and efficient techniques whereby a UE receives a SHR configuration from a RAN node, with the SHR configuration including one or more of the following:
a list of T312 thresholds, where each entry corresponds to a specific frequency, a specific measurement object, a specific measurement identity, or a specific reporting configuration identity;
a specific indication of which measurement frequency related configuration is applicable to the T312 threshold included in the SHR configuration;
an implicit indication that the T312 threshold is applicable to measurements on the frequency of a HO target cell; and
an implicit indication that the T312 threshold is applicable to measurements on the frequencies of CHO candidate target cell(s).

The UE can store the SHR configuration received in this manner and use it to trigger sending of a SHR whenever needed while operating in RRC_CONNECTED state. The UE's SHR includes at least one of the following:
indication of which measurement object(s) met the triggering condition;
indication of which measurement identity(ies) met the triggering condition;
indication of which reporting configuration(s) met the triggering condition;
indication of which reporting configuration ID(s) met the triggering condition;
indication of which candidate target cell ID(s) met the triggering condition
indication of which frequency(ies) met the triggering condition; and
the T312 value configured by the network, associated with the triggering condition that was met.

In this manner, embodiments can facilitate more detailed UE reporting of successful handovers, which enables the network to know which frequency-related measurements satisfied the T312-related triggering condition for the SHR. This further enables the network to better optimize the T312 configurations related to that frequency, thereby improving mobility robustness for UEs operating in the network.

The following description refers to source nodes and target nodes, which in general are RAN nodes such as base stations. These RAN nodes can be LTE nodes (e.g., eNB or ng-eNB), NR nodes (e.g., gNB or en-gNB), or units of such nodes (e.g., CU or DU).

In the following, the terms “successful handover configuration”, “successful handover report configuration”, and “SHR configuration” are used interchangeably and/or synonymously unless specifically noted or unless a different meaning is clear from a specific context of use. All of these terms refer to a configuration sent by the network to a UE that instructs the UE to send a report including information (e.g., measurements) pertaining to a successful execution of a handover (e.g., reconfiguration with sync). For example, such a configuration can include thresholds (e.g., thresholdPercentageT312 for timer T312) that when met (e.g., T312 value is greater than thresholdPercentageT312) trigger the UE to send a SHR to the network. Although T312 is used as example to facilitate explanation, the described techniques are applicable to all supervision timers associated with a measurement identity, a reporting identity, etc.

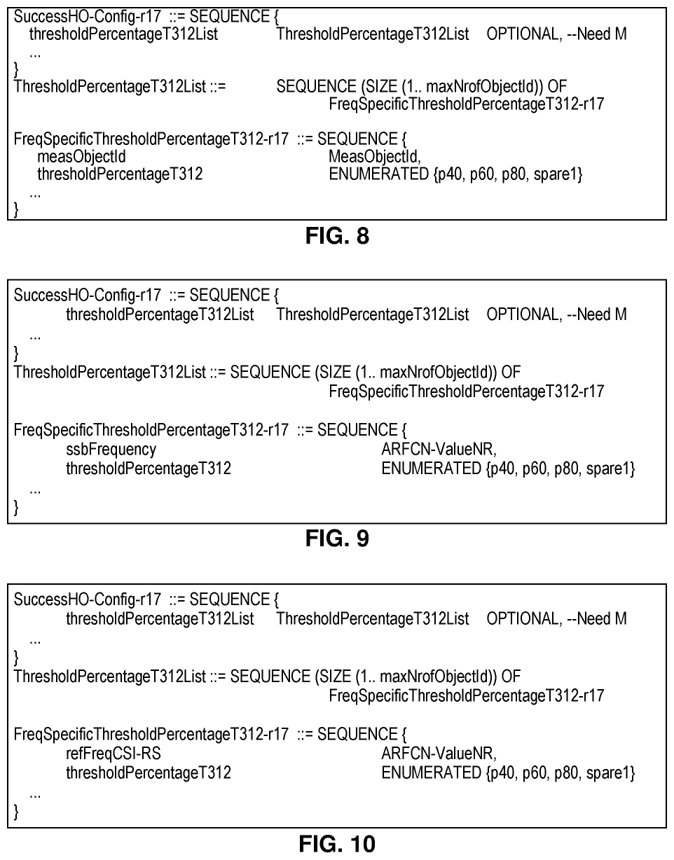

In some embodiments, the network sends the UE an SHR configuration that includes a list of T312 thresholds, with each entry in the list corresponding to T312 threshold associated with a measurements for a specific frequency. FIG. 8 shows an exemplary ASN.1 data structure for a SuccessHO-Config-r17 information element (IE) according to some of these embodiments. In this example, the network configures a thresholdPercentageT312List of FreqSpecificThresholdPercentageT312 entries. Each of these entries specifies the thresholdPercentageT312 that applies to a specific measObjectId. When a reportConfig associated with a measObjectId (and having useT312 set to true) triggers a measurement report and starts the T312 timer, at the time of receiving the HO command the UE evaluates the expired time of the T312 timer against the thresholdPercentageT312 associated with the measObjectId in the thresholdPercentageT312List. If the percentage expired time is above the specific thresholdPercentageT312, then the SHR will be triggered.

In other of these embodiments, each FreqSpecificThresholdPercentageT312 entry specifies the thresholdPercentageT312 that applies to a specific ARFCN value for a synchronization signal/PBCH block (SSB) transmission frequency location, ssbFrequency. When a reportConfig associated with a measurement object having ssbFrequency (and having useT312 set to true) triggers a measurement report and starts the T312 timer, at the time of receiving the HO command the UE evaluates the expired time of the T312 timer against the thresholdPercentageT312 associated with ssbFrequency in the thresholdPercentageT312List. If the percentage expired time is above the specific thresholdPercentageT312, then the SHR will be triggered. FIG. 9 shows an exemplary ASN.1 data structure for a SuccessHO-Config-r17 IE according to these embodiments.

In other of these embodiments, each FreqSpecificThresholdPercentageT312 entry specifies the thresholdPercentageT312 that applies to a specific ARFCN value for a channel state information reference signal (CSI-RS) transmission frequency location, refFreqCSI-RS. When a reportConfig associated with a measurement object having refFreqCSI-RS (and having useT312 set to true) triggers a measurement report and starts the T312 timer, at the time of receiving the HO command the UE evaluates the expired time of the T312 timer against the thresholdPercentageT312 associated with refFreqCSI-RS in the thresholdPercentageT312List. If the percentage expired time is above the specific thresholdPercentageT312, then the SHR will be triggered. FIG. 10 shows an exemplary ASN.1 data structure for a SuccessHO-Config-r17 IE according to these embodiments.

One advantage of the above-described embodiments is that the network can provide frequency-specific T312 thresholds as part of SHR configuration and control SHR triggering conditions more accurately with a finer granularity. When used together with certain SHR reporting embodiments discussed below, the above-described embodiments enable the network can deduce which measID-linked T312 configuration met the corresponding thresholdPercentageT312. This further aids the measID-specific T312 configuration tuning.

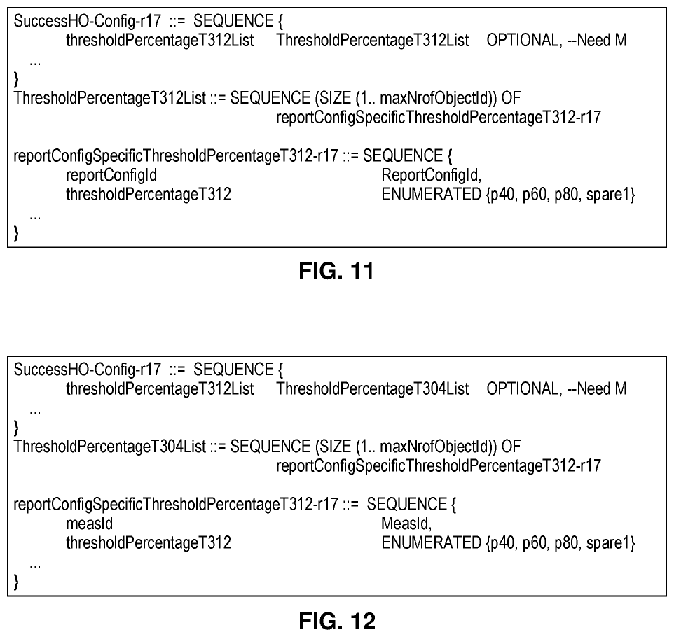

In other embodiments, the network sends the UE an SHR configuration that includes a list of T312 thresholds, with each entry in the list corresponding to T312 threshold associated with a specific reporting configuration. FIG. 11 shows an exemplary ASN.1 data structure for a SuccessHO-Config-r17 IE according to some of these embodiments. In this example, the network configures a thresholdPercentageT312List of reportConfigSpecificThresholdPercentageT312 entries. Each of these entries specifies the thresholdPercentageT312 that applies to a specific reportConfigId. For each entry, an SHR is triggered when the percentage elapsed time of the T312 initiated upon on the transmission of the measurement report for the corresponding reportConfigId meets the corresponding thresholdPercentageT312.

One advantage of the above-described embodiments is that the network can provide reporting configuration-specific T312 thresholds as part of SHR configuration and control SHR triggering conditions more accurately with a finer granularity. When used together with certain SHR reporting embodiments discussed below, the above-described embodiments enable the network can deduce which measID-linked T312 configuration met the corresponding thresholdPercentageT312. This further aids the measID-specific T312 configuration tuning.

In other embodiments, the network sends the UE an SHR configuration that includes a list of T312 thresholds, with each entry in the list corresponding to T312 threshold associated with a specific measurement identity (measID). FIG. 12 shows an exemplary ASN.1 data structure for a SuccessHO-Config-r17 IE according to these embodiments. In this example, the network configures a thresholdPercentageT312List of reportConfigSpecificThresholdPercentageT312 entries. Each of these entries specifies the thresholdPercentageT312 that applies to a specific measId. For each entry, an SHR is triggered when the percentage elapsed time of the T312 initiated upon on the transmission of the measurement report for the corresponding measId meets the corresponding thresholdPercentageT312.

In other embodiments, the network sends the UE an SHR configuration that includes a single T312-related threshold. Upon HO initiation to a target cell, the UE compares this configured T312 threshold against the percentage elapsed time of the T312 timer value in the measurement object configuration linked to the frequency on which the target cell transmits its SSBs/CSI-RSs. For example, the network provides a thresholdPercentageT312 as part of the SHR configuration. Upon HO initiation to a target cell, the UE identifies the measObject configuration associated with the target cell SSB and/or CSI-RS, i.e., ssbFrequency (e.g., ARFCN) included in the measObject is the same as ssbFrequency in which the target cell transmits SSBs and/or refFreqCSI-RS (e.g., ARFCN) and/or refFreqCSI-RS included in the measObject is the same as frequencies in which the target cell transmits CSI-RSs. The UE uses the T312 timer value in the measObject having the matching characteristic(s) to compute the percentage elapsed time of the T312.

In a variant of these embodiments, the network may configure multiple T312 thresholds for the UE when the UE is configured with CHO, with each of the configured T312 thresholds being associated with a frequency on which one or more of the candidate target cells are operating. Upon HO initiation to a candidate target cell, the UE compares each configured T312 threshold for each frequency in which the candidate target cells are operating, against the percentage elapsed time of the T312 timer value in the measurement object configuration for each frequency on which the candidate target cell transmits its SSBs/CSI-RSs.

Once configured with an SHR configuration according to any of the embodiments described above, the UE include various information in an SHR sent to the network.

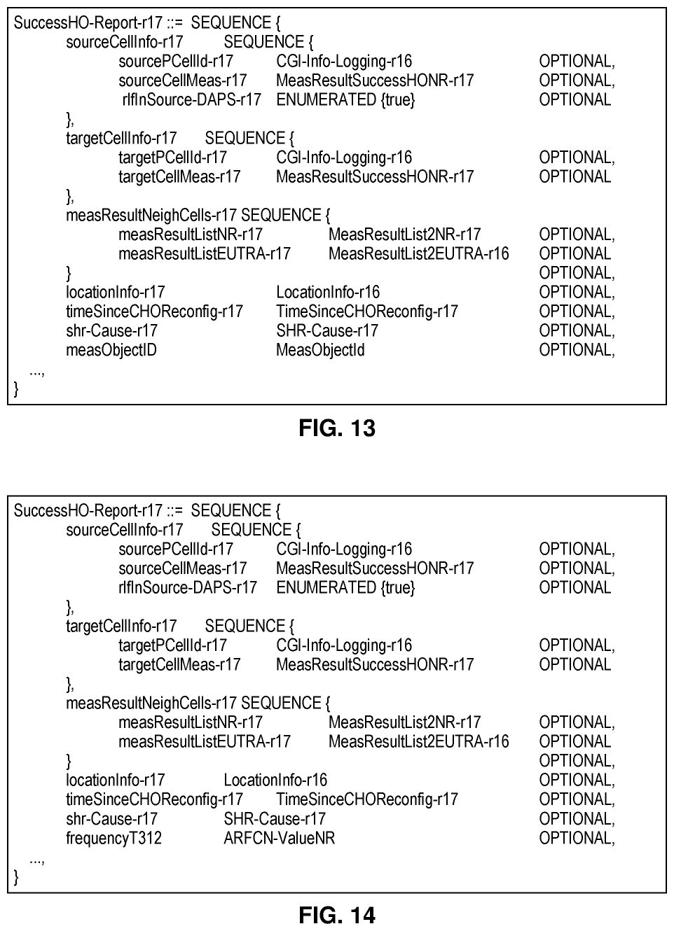

In some embodiments, the UE can include in the SHR an indication of the measurement object whose measurements triggered a measurement report that led to initiation of T312 and determination that T312's elapsed time met the T312-related criterion that triggered the SHR. FIG. 13 shows an exemplary ASN.1 data structure for a SuccessHO-Report-r17 IE according to these embodiments. For example, the UE could include a value of “1” in the measObjectID field to indicate that a measurement report triggered based on measurements associated with measObjectID=1 led to the UE's initiation of T312 and determination that T312's elapsed time met the T312-related criterion (e.g., thresholdPercentageT312) that triggered the SHR.

In other embodiments, the UE can include in the SHR the ARFCN value corresponding to the SSB transmission frequency location of the measurements that triggered a measurement report that led to initiation of T312 and determination that T312's elapsed time met the T312-related criterion that triggered the SHR. FIG. 14 shows an exemplary ASN.1 data structure for a SuccessHO-Report-r17 IE according to these embodiments. In this example, the UE includes in the SHR the field frequencyT312 containing the ARFCN on which the UE made the SSB measurements (associated with a measID) that led to the UE's initiation of T312 and determination that T312's elapsed time met the T312-related criterion (e.g., thresholdPercentageT312) that triggered the SHR. As a variant of these embodiments, the UE can report the ARFCN value corresponding to the CSI-RS transmission frequency location of the measurements that triggered a measurement report that led to initiation of T312 and determination that T312's elapsed time met the T312-related criterion that triggered the SHR.

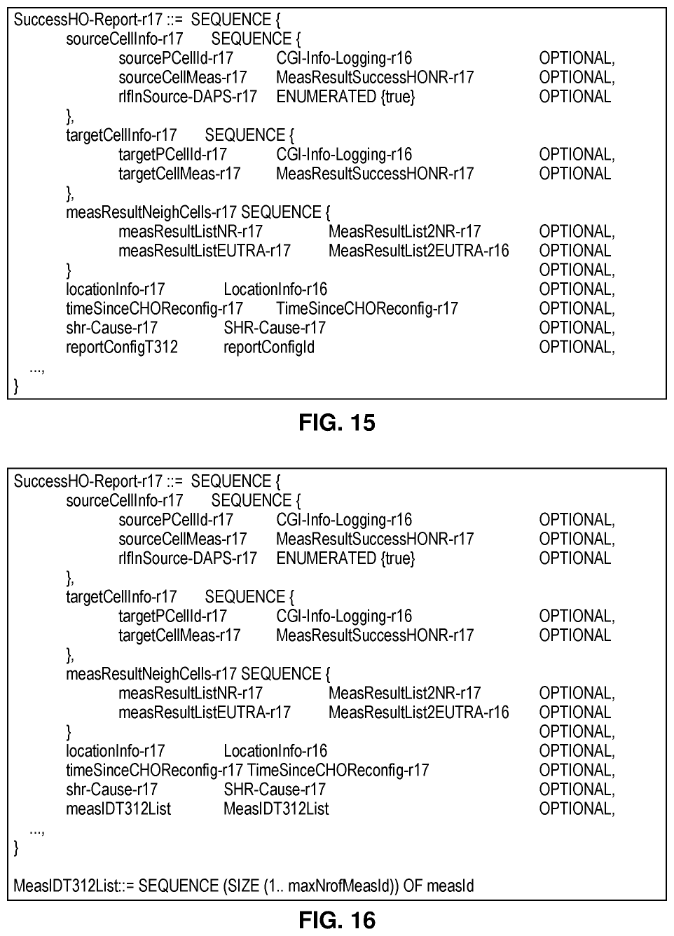

In other embodiments, the UE can include in the SHR an identifier of the reporting configuration (reportConfig) associated with the measID that triggered initiation of T312 and determination that T312's elapsed time met the T312-related criterion that triggered the SHR. FIG. 15 shows an exemplary ASN.1 data structure for a SuccessHO-Report-r17 IE according to these embodiments. For example, the UE could include a value of “1” in the reportConfigT312 field to indicate that a measurement report triggered based on measurements associated with reportConfigId=1 led to the UE's initiation of T312 and determination that T312's elapsed time met the T312-related criterion (e.g., thresholdPercentageT312) that triggered the SHR.

In other embodiments, the UE can include in the SHR the value of T312 configured in the measObject associated with the measurement report that triggered initiation of T312 and determination that T312's elapsed time met the T312-related criterion that triggered the SHR. By including the configured value of T312 whose elapsed time had triggered the SHR, the UE can enable a HO source cell to optimize and/or improve its T312 configuration even if no longer has the UE's context when receiving the SHR. In some variants, the UE includes the actual elapsed T312 time in the SHR. By doing so, the UE can proactively aid the configuration of optimal T312 configurations in the future.

In other embodiments, the UE can include in the SHR some configurations related to RLF timers and/or counters. For example, the UE can include values of T310 and T311 timers and/or N310 and N311 counters that were configured for the UE. By providing the values of RLF timers and counters used before triggering the SHR, the UE could also aid the network to optimize and/or improve configuration of these timers and counters for other UEs. The triggering of timer T312 is dependent on T310 being running and thus T310 and N310 would impact the initiation of T312. In the same way, N311 would impact when the T312 timer is stopped. Thus, knowing the values of these RLF timers and counters would help the network to tune these parameters as well.

In other embodiments, the UE can include in the SHR an indication of whether the T312 timer was initiated due to the triggering of a measurement report associated with a frequency on which the target cell transmits its SSBs and/or CSI-RS.

In other embodiments, the UE can include in the SHR identifier(s) of the measID(s) associated with the measObject whose configured T312 timer triggered the SHR. FIG. 16 shows an exemplary ASN.1 data structure for a SuccessHO-Report-r17 IE according to these embodiments. For example, the UE could include the values of “1” and “2” in measIDT312List as the measIDs associated with the measObject whose T312 configuration met the SHR triggering condition (e.g., thresholdPercentageT312).

In other embodiments, the UE can include in the SHR an indication of whether SSB-based measurements or the CSI-RS-based measurements led to the initiation of the T312 that fulfilled the SHR triggering criterion. For example, the SHR can include a variable with two enumerated values: “SSB”, indicating that SSB measurements triggered the measurement report; or “CSI-RS”, indicating that CSI-RS measurements triggered the measurement report.

In other embodiments, the UE can include in the SHR frequency-related information (e.g., measObjectID or ARFCN value included in the corresponding measObjectID) of other measurement reports that were triggered while T312 was already running. For example, the UE might initiate T312 upon transmission of a measurement report associated with measurements of frequency-1. Subsequently, while T312 is already running, the UE may transmit another measurement report associated with measurements of frequency-2. According to these embodiments, the UE includes the frequency-related information for frequency-2 in the SHR that is triggered by the T312-related criterion associated with frequency-1.

In other embodiments, the UE includes the frequency-related information for frequency-2 in a failure report (e.g., RLF) only when transmission of the measurement report associated with frequency-2 would have initiated T312 timer, if it was not already initiated by the previous measurement report.

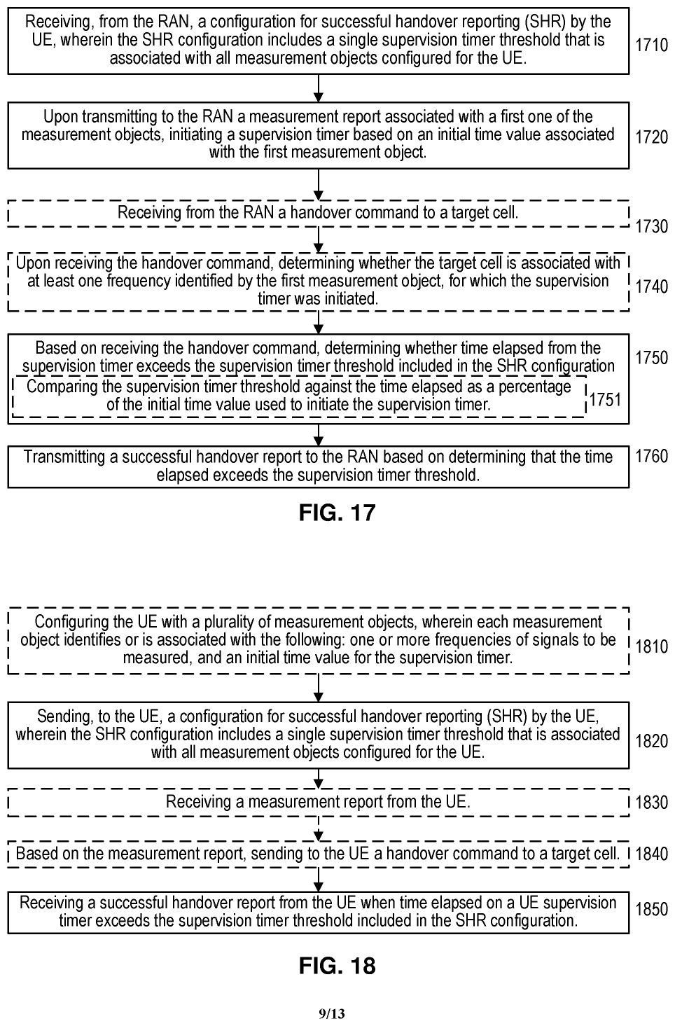

Various features of the embodiments described above correspond to various operations illustrated in FIGS. 17-18, which show exemplary methods (e.g., procedures) for a UE and a RAN node, respectively. In other words, various features of the operations described below correspond to various embodiments described above. Furthermore, the exemplary methods shown in FIGS. 17-18 can be used cooperatively to provide various benefits, advantages, and/or solutions to problems described herein. Although FIGS. 17-18 show specific blocks in particular orders, the operations of the exemplary methods can be performed in different orders than shown and can be combined and/or divided into blocks having different functionality than shown. Optional blocks or operations are indicated by dashed lines.

In particular, FIG. 17 shows an exemplary method (e.g., procedure) for providing successful handover reports to a RAN, according to various embodiments of the present disclosure. The exemplary method can be performed by a UE (e.g., wireless device, etc.) such as described elsewhere herein.

The exemplary method can include the operations of block 1710, where the UE can receive, from the RAN, a configuration for successful handover reporting (SHR) by the UE. The SHR configuration includes a single supervision timer threshold that is associated with all measurement objects configured for the UE. The exemplary method can also include the operations of block 1720, where upon transmitting to the RAN a measurement report associated with a first one of the measurement objects, the UE can initiate a supervision timer based on an initial time value associated with the first measurement object. The exemplary method can also include the operations of block 1750, where based on receiving from the RAN a handover command to a target cell, the UE can determine whether time elapsed from the supervision timer exceeds the supervision timer threshold included in the SHR configuration. The exemplary method can also include the operations of block 1760, where the UE can transmit a successful handover report to the RAN based on determining that the time elapsed exceeds the supervision timer threshold (e.g., in block 1750).

In some embodiments, the supervision timer threshold indicates a percentage of an initial time value used to initiate the supervision timer. In such case, determining whether the time elapsed from the supervision timer exceeds the supervision timer threshold in block 1750 can include the operations of sub-block 1751, where the UE can compare the supervision timer threshold against the time elapsed as a percentage of the initial time value used to initiate the supervision timer. In some embodiments, the supervision timer is T312 and the supervision timer threshold is thresholdPercentageT312.

In some embodiments, the UE is configured with a plurality of measurement objects and with each measurement object identifies or is associated with the following: an initial time value for the supervision timer, and one or more frequencies of signals to be measured. In some of these embodiments, the exemplary method can also include the operations of block 1740, where upon receiving the handover command, the UE can determine whether the target cell is associated with at least one frequency identified by the first measurement object, for which the supervision timer was initiated. In a specific example discussed above, the UE determines whether ssbFrequency (e.g., ARFCN) in which the target cell transmits SSBs is the same as ssbFrequency included in the measObject for which the supervision timer was started.

In such embodiments, determining whether time elapsed from the supervision timer exceeds the supervision timer threshold in block 1750 is based on determining in block 1740 that the target cell is associated with at least one frequency identified by the first measurement object. Put differently, in these embodiments, transmitting the successful handover report in block 1760 is conditioned on positive determinations in blocks 1740 and 1750.

In various embodiments, the successful handover report can include one or more of the following:
a measurement object identifier associated with measurements that triggered the measurement report (e.g., as illustrated in FIG. 13);
identifiers of one or more measurements that triggered the measurement report (e.g., as illustrated in FIG. 16);
an identifier of a reporting configuration associated with a measurement identifier that is associated with the measurements that triggered the measurement report (e.g., as illustrated in FIG. 15);
a channel number on which the measurements that triggered the measurement report were made (e.g., as illustrated in FIG. 14); and
the initial time value used when initiating the supervision timer.

In some of these embodiments, the successful handover report can also include one or more of the following:
values of one or more other timers or counters that triggered the measurement report;
type of signal on which the measurements that triggered the measurement report were made; and
frequency information related to one or more further measurement reports that were triggered while the supervision timer was running.

In addition, FIG. 18 shows an exemplary method (e.g., procedure) for receiving successful handover reports from a UE, according to various embodiments of the present disclosure. The exemplary method can be performed by a RAN, specifically one or more RAN nodes (e.g., base stations, eNBs, gNBs, ng-eNBs, TRPs, etc.) such as described elsewhere herein.

The exemplary method can include the operations of block 1820, where the RAN can send, to the UE, a configuration for successful handover reporting (SHR) by the UE. The SHR configuration includes a single supervision timer threshold that is associated with all measurements configured for the UE. The exemplary method can also include the operations of block 1850, where the RAN can subsequently receive a successful handover report from the UE when time elapsed on a UE supervision timer exceeds the supervision timer threshold included in the SHR configuration.

In some embodiments, the supervision timer threshold indicates a percentage of an initial time value used to initiate the supervision timer, the successful handover report is received when the time elapsed from the UE supervision timer, as a percentage of the initial time value used to initiate the supervision timer, exceeds the supervision timer threshold. In some embodiments, the supervision timer is T312 and the supervision timer threshold is thresholdPercentageT312.

In some embodiments, the exemplary method can also include the operations of block 1810, where the RAN can configure the UE with a plurality of measurement objects, wherein each measurement object identifies or is associated with the following: one or more frequencies of signals to be measured, and an initial time value for the supervision timer.

In some embodiments, the exemplary method can also include the operations of blocks 1830-1840, where the RAN can receive a measurement report from the UE and based on the measurement report, send to the UE a handover command to a target cell. In such case, the successful handover report is received responsive to the handover command. In some of these embodiments, the measurement report is associated with a first measurement object configured for the UE and the successful handover report is received when the target cell is associated with at least one frequency identified by the first measurement object. In a specific example discussed above, a successful handover report is received when ssbFrequency (e.g., ARFCN) in which the target cell transmits SSBs is the same as ssbFrequency included in the measObject for which the UE initiated its supervision timer upon transmitting the measurement report received by the RAN in block 1830.

In various embodiments, the successful handover report can include any of the information described above in relation to the UE method embodiments shown in FIG. 17.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

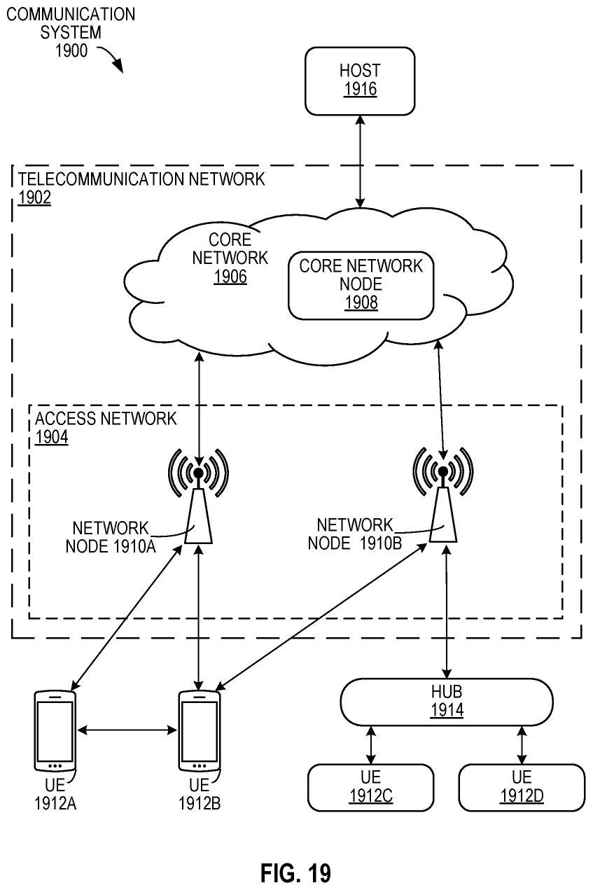

FIG. 19 shows an example of a communication system 1900 in accordance with some embodiments. In this example, communication system 1900 includes a telecommunication network 1902 that includes an access network 1904, such as a radio access network (RAN), and a core network 1906, which includes one or more core network nodes 1908. Access network 1904 includes one or more access network nodes, such as network nodes 1910a and 1910b (one or more of which may be generally referred to as network nodes 1910), or any other similar 3GPP access node or non-3GPP access point. Network nodes 1910 facilitate direct or indirect connection of UEs, such as by connecting UEs 1912a-d (one or more of which may be generally referred to as UEs 1912) to core network 1906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1900 may include any number of wired or wireless networks, network nodes, UEs, and/or any other components or systems that may facilitate or participate in the communication of data and/or signals whether via wired or wireless connections. Communication system 1900 may include and/or interface with any type of communication, telecommunication, data, cellular, radio network, and/or other similar type of system.

UEs 1912 may be any of a wide variety of communication devices, including wireless devices arranged, configured, and/or operable to communicate wirelessly with network nodes 1910 and other communication devices. Similarly, network nodes 1910 are arranged, capable, configured, and/or operable to communicate directly or indirectly with UEs 1912 and/or with other network nodes or equipment in telecommunication network 1902 to enable and/or provide network access, such as wireless network access, and/or to perform other functions, such as administration in telecommunication network 1902.

In the depicted example, core network 1906 connects network nodes 1910 to one or more hosts, such as host 1916. These connections may be direct or indirect via one or more intermediary networks or devices. In other examples, network nodes may be directly coupled to hosts. Core network 1906 includes one more core network nodes (e.g., core network node 1908) that are structured with hardware and software components. Features of these components may be substantially similar to those described with respect to the UEs, network nodes, and/or hosts, such that the descriptions thereof are generally applicable to the corresponding components of core network node 1908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1916 may be under the ownership or control of a service provider other than an operator or provider of access network 1904 and/or telecommunication network 1902, and may be operated by the service provider or on behalf of the service provider. Host 1916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1900 of FIG. 19 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1902 is a cellular network that implements 3GPP standardized features. Accordingly, telecommunication network 1902 may support network slicing to provide different logical networks to different devices that are connected to telecommunication network 1902. For example, telecommunication network 1902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1912 are configured to transmit and/or receive information without direct human interaction. For instance, a UE may be designed to transmit information to access network 1904 on a predetermined schedule, when triggered by an internal or external event, or in response to requests from access network 1904. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 1914 communicates with access network 1904 to facilitate indirect communication between one or more UEs (e.g., UE 1912c and/or 1912d) and network nodes (e.g., network node 1910b). In some examples, hub 1914 may be a controller, router, content source and analytics, or any of the other communication devices described herein regarding UEs. For example, hub 1914 may be a broadband router enabling access to core network 1906 for the UEs. As another example, hub 1914 may be a controller that sends commands or instructions to one or more actuators in the UEs. Commands or instructions may be received from the UEs, network nodes 1910, or by executable code, script, process, or other instructions in hub 1914. As another example, hub 1914 may be a data collector that acts as temporary storage for UE data and, in some embodiments, may perform analysis or other processing of the data. As another example, hub 1914 may be a content source. For example, for a UE that is a VR headset, display, loudspeaker or other media delivery device, hub 1914 may retrieve VR assets, video, audio, or other media or data related to sensory information via a network node, which hub 1914 then provides to the UE either directly, after performing local processing, and/or after adding additional local content. In still another example, hub 1914 acts as a proxy server or orchestrator for the UEs, in particular in if one or more of the UEs are low energy IoT devices.

Hub 1914 may have a constant/persistent or intermittent connection to the network node 1910b. Hub 1914 may also allow for a different communication scheme and/or schedule between hub 1914 and UEs (e.g., UE 1912c and/or 1912d), and between hub 1914 and core network 1906. In other examples, hub 1914 is connected to core network 1906 and/or one or more UEs via a wired connection. Moreover, hub 1914 may be configured to connect to an M2M service provider over access network 1904 and/or to another UE over a direct connection. In some scenarios, UEs may establish a wireless connection with network nodes 1910 while still connected via hub 1914 via a wired or wireless connection. In some embodiments, hub 1914 may be a dedicated hub—that is, a hub whose primary function is to route communications to/from the UEs from/to the network node 1910b. In other embodiments, hub 1914 may be a non-dedicated hub—that is, a device which is capable of operating to route communications between the UEs and network node 1910b, but which is additionally capable of operating as a communication start and/or end point for certain data channels.

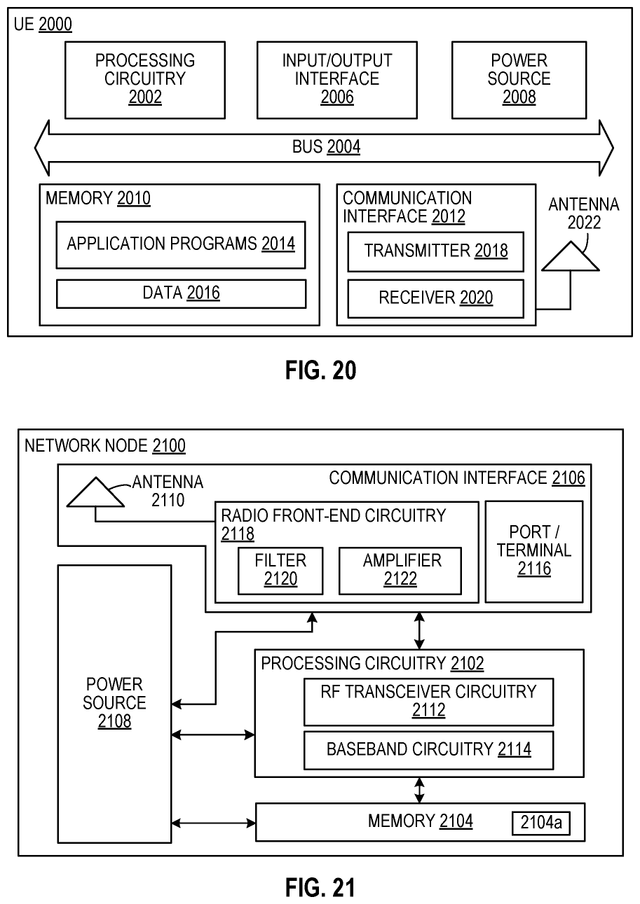

FIG. 20 shows a UE 2000 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 2000 includes processing circuitry 2002 that is operatively coupled via a bus 2004 to an input/output interface 2006, a power source 2008, a memory 2010, a communication interface 2012, and/or any other component, or any combination thereof. Certain UEs may utilize all or a subset of the components shown in FIG. 20. The level of integration between the components may vary from one UE to another UE. Further, certain UEs may contain multiple instances of a component, such as multiple processors, memories, transceivers, transmitters, receivers, etc.

Processing circuitry 2002 is configured to process instructions and data and may be configured to implement any sequential state machine operative to execute instructions stored as machine-readable computer programs in memory 2010. Processing circuitry 2002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 2002 may include multiple central processing units (CPUs).

In the example, input/output interface 2006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 2000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 2008 is structured as a battery or battery pack. Other types of power sources, such as an external power source (e.g., an electricity outlet), photovoltaic device, or power cell, may be used. Power source 2008 may further include power circuitry for delivering power from power source 2008 itself, and/or an external power source, to the various parts of UE 2000 via input circuitry or an interface such as an electrical power cable. Delivering power may be, for example, for charging of power source 2008. Power circuitry may perform any formatting, converting, or other modification to the power from power source 2008 to make the power suitable for the respective components of UE 2000 to which power is supplied.

Memory 2010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 2010 includes one or more application programs 2014, such as an operating system, web browser application, a widget, gadget engine, or other application, and corresponding data 2016. Memory 2010 may store, for use by UE 2000, any of a variety of various operating systems or combinations of operating systems.

Memory 2010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 2010 may allow UE 2000 to access instructions, application programs and the like, stored on transitory or non-transitory memory media, to off-load data, or to upload data. An article of manufacture, such as one utilizing a communication system may be tangibly embodied as or in memory 2010, which may be or comprise a device-readable storage medium.

Processing circuitry 2002 may be configured to communicate with an access network or other network using communication interface 2012. Communication interface 2012 may comprise one or more communication subsystems and may include or be communicatively coupled to an antenna 2022. Communication interface 2012 may include one or more transceivers used to communicate, such as by communicating with one or more remote transceivers of another device capable of wireless communication (e.g., another UE or a network node in an access network). Each transceiver may include a transmitter 2018 and/or a receiver 2020 appropriate to provide network communications (e.g., optical, electrical, frequency allocations, and so forth). Moreover, transmitter 2018 and receiver 2020 may be coupled to one or more antennas (e.g., antenna 2022) and may share circuit components, software or firmware, or alternatively be implemented separately.

In the illustrated embodiment, communication functions of communication interface 2012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 2000 shown in FIG. 20.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 21 shows a network node 2100 in accordance with some embodiments. Examples of network nodes include, but are not limited to, access points (APs, e.g., radio access points) and base stations (e.g., radio base stations, Node Bs, eNBs, gNBs, etc.).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 2100 includes processing circuitry 2102, memory 2104, communication interface 2106, and power source 2108. Network node 2100 may be composed of multiple physically separate components (e.g., a NodeB component and a RNC component, or a BTS component and a BSC component, etc.), which may each have their own respective components. In certain scenarios in which network node 2100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 2100 may be configured to support multiple radio access technologies (RATs). In such embodiments, some components may be duplicated (e.g., separate memory 2104 for different RATs) and some components may be reused (e.g., a same antenna 2110 may be shared by different RATs). Network node 2100 may also include multiple sets of the various illustrated components for different wireless technologies integrated into network node 2100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2100.

Processing circuitry 2102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2100 components, such as memory 2104, to provide network node 2100 functionality.

In some embodiments, processing circuitry 2102 includes a system on a chip (SOC). In some embodiments, processing circuitry 2102 includes one or more of radio frequency (RF) transceiver circuitry 2112 and baseband processing circuitry 2114. In some embodiments, RF transceiver circuitry 2112 and baseband processing circuitry 2114 may be on separate chips (or sets of chips), boards, or units, such as radio units and digital units. In alternative embodiments, part or all of RF transceiver circuitry 2112 and baseband processing circuitry 2114 may be on the same chip or set of chips, boards, or units.

Memory 2104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 2102. Memory 2104 may store any suitable instructions, data, or information, including a computer program, software, an application including one or more of logic, rules, code, tables, and/or other instructions (collectively denoted computer program product 2104a) capable of being executed by processing circuitry 2102 and utilized by network node 2100. Memory 2104 may be used to store any calculations made by processing circuitry 2102 and/or any data received via communication interface 2106. In some embodiments, processing circuitry 2102 and memory 2104 is integrated.

Communication interface 2106 is used in wired or wireless communication of signaling and/or data between a network node, access network, and/or UE. As illustrated, communication interface 2106 comprises port(s)/terminal(s) 2116 to send and receive data, for example to and from a network over a wired connection. Communication interface 2106 also includes radio front-end circuitry 2118 that may be coupled to, or in certain embodiments a part of, antenna 2110. Radio front-end circuitry 2118 comprises filters 2120 and amplifiers 2122. Radio front-end circuitry 2118 may be connected to an antenna 2110 and processing circuitry 2102. The radio front-end circuitry may be configured to condition signals communicated between antenna 2110 and processing circuitry 2102. Radio front-end circuitry 2118 may receive digital data that is to be sent out to other network nodes or UEs via a wireless connection. Radio front-end circuitry 2118 may convert the digital data into a radio signal having the appropriate channel and bandwidth parameters using a combination of filters 2120 and/or amplifiers 2122. The radio signal may then be transmitted via antenna 2110. Similarly, when receiving data, antenna 2110 may collect radio signals which are then converted into digital data by radio front-end circuitry 2118. The digital data may be passed to processing circuitry 2102. In other embodiments, the communication interface may comprise different components and/or different combinations of components.

In certain alternative embodiments, network node 2100 does not include separate radio front-end circuitry 2118, instead, processing circuitry 2102 includes radio front-end circuitry and is connected to antenna 2110. Similarly, in some embodiments, all or some of RF transceiver circuitry 2112 is part of communication interface 2106. In still other embodiments, communication interface 2106 includes one or more ports or terminals 2116, radio front-end circuitry 2118, and RF transceiver circuitry 2112, as part of a radio unit (not shown), and communication interface 2106 communicates with the baseband processing circuitry 2114, which is part of a digital unit (not shown).

Antenna 2110 may include one or more antennas, or antenna arrays, configured to send and/or receive wireless signals. Antenna 2110 may be coupled to radio front-end circuitry 2118 and may be any type of antenna capable of transmitting and receiving data and/or signals wirelessly. In certain embodiments, antenna 2110 is separate from network node 2100 and connectable to network node 2100 through an interface or port.

Antenna 2110, communication interface 2106, and/or processing circuitry 2102 may be configured to perform any receiving operations and/or certain obtaining operations described herein as being performed by the network node. Any information, data and/or signals may be received from a UE, another network node and/or any other network equipment. Similarly, antenna 2110, communication interface 2106, and/or processing circuitry 2102 may be configured to perform any transmitting operations described herein as being performed by the network node. Any information, data and/or signals may be transmitted to a UE, another network node and/or any other network equipment.

Power source 2108 provides power to the various components of network node 2100 in a form suitable for the respective components (e.g., at a voltage and current level needed for each respective component). Power source 2108 may further comprise, or be coupled to, power management circuitry to supply the components of network node 2100 with power for performing the functionality described herein. For example, network node 2100 may be connectable to an external power source (e.g., the power grid, an electricity outlet) via an input circuitry or interface such as an electrical cable, whereby the external power source supplies power to power circuitry of power source 2108. As a further example, power source 2108 may comprise a source of power in the form of a battery or battery pack which is connected to, or integrated in, power circuitry. The battery may provide backup power should the external power source fail.

Embodiments of network node 2100 may include additional components beyond those shown in FIG. 21 for providing certain aspects of the network node's functionality, including any of the functionality described herein and/or any functionality necessary to support the subject matter described herein. For example, network node 2100 may include user interface equipment to allow input of information into network node 2100 and to allow output of information from network node 2100. This may allow a user to perform diagnostic, maintenance, repair, and other administrative functions for network node 2100.

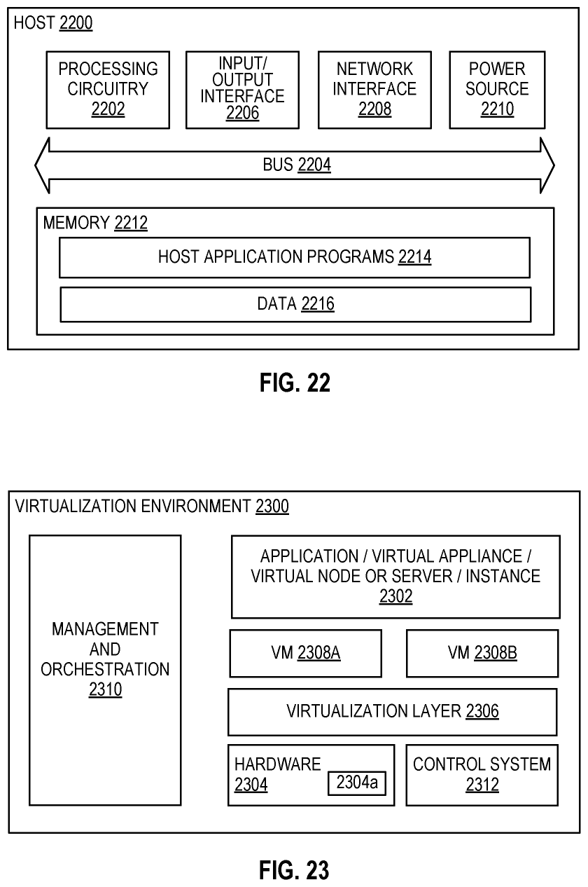

FIG. 22 is a block diagram of a host 2200, which may be an embodiment of host 1916 of FIG. 19, in accordance with various aspects described herein. As used herein, host 2200 may be or comprise various combinations hardware and/or software, including a standalone server, a blade server, a cloud-implemented server, a distributed server, a virtual machine, container, or processing resources in a server farm. Host 2200 may provide one or more services to one or more UEs.

Host 2200 includes processing circuitry 2202 that is operatively coupled via a bus 2204 to an input/output interface 2206, a network interface 2208, a power source 2210, and a memory 2212. Other components may be included in other embodiments. Features of these components may be substantially similar to those described with respect to the devices of previous figures, such as FIGS. 20-21, such that the descriptions thereof are generally applicable to the corresponding components of host 2200.

Memory 2212 may include one or more computer programs including one or more host application programs 2214 and data 2216, which may include user data, e.g., data generated by a UE for host 2200 or data generated by host 2200 for a UE. Embodiments of host 2200 may utilize only a subset or all of the components shown. Host application programs 2214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 2214 may also provide for user authentication and licensing checks and may periodically report health, routes, and content availability to a central node, such as a device in or on the edge of a core network. Accordingly, host 2200 may select and/or indicate a different host for over-the-top services for a UE. Host application programs 2214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 23 is a block diagram illustrating a virtualization environment 2300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2302 (which may alternatively be called software instances, virtual appliances, network functions, virtual nodes, virtual network functions, etc.) are run in the virtualization environment 2300 to implement some of the features, functions, and/or benefits of some of the embodiments disclosed herein.

Hardware 2304 includes processing circuitry, memory that stores software and/or instructions (collectively denoted computer program product 2304a) executable by hardware processing circuitry, and/or other hardware devices as described herein, such as a network interface, input/output interface, and so forth. Software may be executed by the processing circuitry to instantiate one or more virtualization layers 2306 (also referred to as hypervisors or virtual machine monitors, VMMs), provide VMs 2308a-b (one or more of which may be generally referred to as VMs 2308), and/or perform any of the functions, features and/or benefits described in relation with some embodiments described herein. Virtualization layer 2306 may present a virtual operating platform that appears like networking hardware to VMs 2308.

VMs 2308 comprise virtual processing, virtual memory, virtual networking or interface and virtual storage, and may be run by a corresponding virtualization layer 2306. Different embodiments of the instance of a virtual appliance 2302 may be implemented on one or more of VMs 2308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2308 may be a software implementation of a physical machine that runs programs as if they were executing on a physical, non-virtualized machine. Each of VMs 2308, and that part of hardware 2304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2308 on top of hardware 2304 and corresponds to application 2302.

Hardware 2304 may be implemented in a standalone network node with generic or specific components. Hardware 2304 may implement some functions via virtualization. Alternatively, hardware 2304 may be part of a larger cluster of hardware (e.g., such as in a data center or CPE) where many hardware nodes work together and are managed via management and orchestration 2310, which, among others, oversees lifecycle management of applications 2302. In some embodiments, hardware 2304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2312 which may alternatively be used for communication between hardware nodes and radio units.

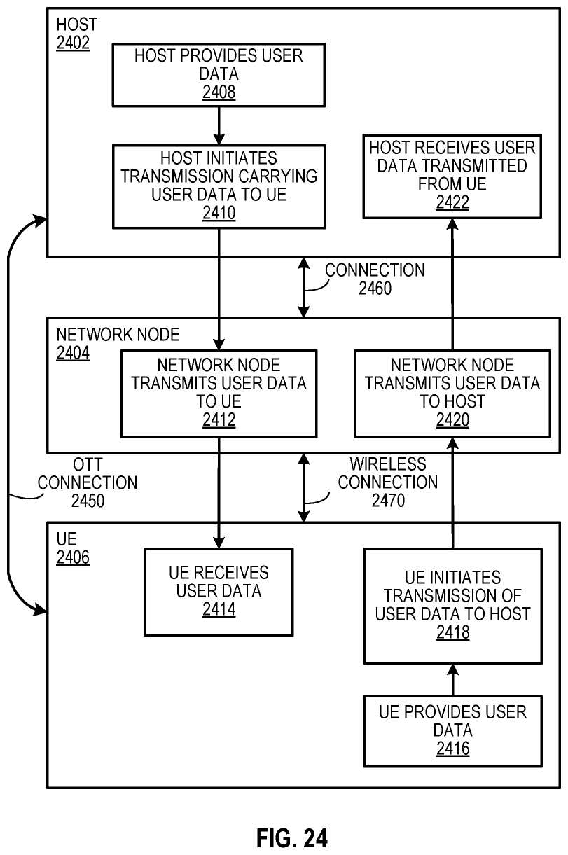

FIG. 24 shows a communication diagram of a host 2402 communicating via a network node 2404 with a UE 2406 over a partially wireless connection in accordance with some embodiments. Example implementations, in accordance with various embodiments, of the UE (such as a UE 1912a of FIG. 19 and/or UE 2000 of FIG. 20), network node (such as network node 1910a of FIG. 19 and/or network node 2100 of FIG. 21), and host (such as host 1916 of FIG. 19 and/or host 2200 of FIG. 22) discussed in the preceding paragraphs will now be described with reference to FIG. 24.

Like host 2200, embodiments of host 2402 include hardware, such as a communication interface, processing circuitry, and memory. Host 2402 also includes software, which is stored in or accessible by host 2402 and executable by the processing circuitry. The software includes a host application that may be operable to provide a service to a remote user, such as UE 2406 connecting via an over-the-top (OTT) connection 2450 extending between UE 2406 and host 2402. In providing the service to the remote user, a host application may provide user data which is transmitted using OTT connection 2450.

Network node 2404 includes hardware enabling it to communicate with host 2402 and UE 2406. Connection 2460 may be direct or pass through a core network (like core network 1906 of FIG. 19) and/or one or more other intermediate networks, such as one or more public, private, or hosted networks. For example, an intermediate network may be a backbone network or the Internet.

UE 2406 includes hardware and software, which is stored in or accessible by UE 2406 and executable by the UE's processing circuitry. The software includes a client application, such as a web browser or operator-specific “app” that may be operable to provide a service to a human or non-human user via UE 2406 with the support of host 2402. In host 2402, an executing host application may communicate with the executing client application via OTT connection 2450 terminating at UE 2406 and host 2402. In providing the service to the user, the UE's client application may receive request data from the host's host application and provide user data in response to the request data. OTT connection 2450 may transfer both the request data and the user data. The UE's client application may interact with the user to generate the user data that it provides to the host application through OTT connection 2450.

OTT connection 2450 may extend via a connection 2460 between host 2402 and network node 2404 and via a wireless connection 2470 between network node 2404 and UE 2406 to provide the connection between host 2402 and UE 2406. Connection 2460 and wireless connection 2470, over which OTT connection 2450 may be provided, have been drawn abstractly to illustrate the communication between host 2402 and UE 2406 via network node 2404, without explicit reference to any intermediary devices and the precise routing of messages via these devices.

As an example of transmitting data via OTT connection 2450, in step 2408, host 2402 provides user data, which may be performed by executing a host application. In some embodiments, the user data is associated with a particular human user interacting with UE 2406. In other embodiments, the user data is associated with a UE 2406 that shares data with host 2402 without explicit human interaction. In step 2410, host 2402 initiates a transmission carrying the user data towards UE 2406. Host 2402 may initiate the transmission responsive to a request transmitted by UE 2406. The request may be caused by human interaction with UE 2406 or by operation of the client application executing on UE 2406. The transmission may pass via network node 2404, in accordance with the teachings of the embodiments described throughout this disclosure. Accordingly, in step 2412, network node 2404 transmits to UE 2406 the user data that was carried in the transmission that host 2402 initiated, in accordance with the teachings of the embodiments described throughout this disclosure. In step 2414, UE 2406 receives the user data carried in the transmission, which may be performed by a client application executed on UE 2406 associated with the host application executed by host 2402.

In some examples, UE 2406 executes a client application which provides user data to host 2402. The user data may be provided in reaction or response to the data received from host 2402. Accordingly, in step 2416, UE 2406 may provide user data, which may be performed by executing the client application. In providing the user data, the client application may further consider user input received from the user via an input/output interface of UE 2406. Regardless of the specific manner in which the user data was provided, UE 2406 initiates, in step 2418, transmission of the user data towards host 2402 via network node 2404. In step 2420, in accordance with the teachings of the embodiments described throughout this disclosure, network node 2404 receives user data from UE 2406 and initiates transmission of the received user data towards host 2402. In step 2422, host 2402 receives the user data carried in the transmission initiated by UE 2406.

One or more of the various embodiments improve the performance of OTT services provided to UE 2406 using OTT connection 2450, in which wireless connection 2470 forms the last segment. More precisely, embodiments described herein provide useful successful handover information that facilitates network operational improvements that can benefit UEs performing subsequent handovers. For example, embodiments facilitate more detailed UE reporting of successful handovers, which enables the network to know which frequency-related measurements satisfied the T312-related triggering condition for successful handover reporting (SHR). This enables the network to better optimize T312 configurations related to that frequency, thereby improving mobility robustness for UEs operating in the network. When networks and UEs improved in this manner are used to deliver OTT services, they increase the value of such services to end users and service providers.

In an example scenario, factory status information may be collected and analyzed by host 2402. As another example, host 2402 may process audio and video data which may have been retrieved from a UE for use in creating maps. As another example, host 2402 may collect and analyze real-time data to assist in controlling vehicle congestion (e.g., controlling traffic lights). As another example, host 2402 may store surveillance video uploaded by a UE. As another example, host 2402 may store or control access to media content such as video, audio, VR or AR which it can broadcast, multicast or unicast to UEs. As other examples, host 2402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 2450 between host 2402 and UE 2406, in response to variations in the measurement results. The measurement procedure and/or the network functionality for reconfiguring the OTT connection may be implemented in software and hardware of host 2402 and/or UE 2406. In some embodiments, sensors (not shown) may be deployed in or in association with other devices through which OTT connection 2450 passes; the sensors may participate in the measurement procedure by supplying values of the monitored quantities exemplified above or by supplying values of other physical quantities from which software may compute or estimate the monitored quantities. The reconfiguring of OTT connection 2450 may include message format, retransmission settings, preferred routing etc.; the reconfiguring need not directly alter the operation of network node 2404. Such procedures and functionalities may be known and practiced in the art. In certain embodiments, measurements may involve proprietary UE signaling that facilitates measurements of throughput, propagation times, latency and the like, by host 2402. The measurements may be implemented in that software causes messages to be transmitted, in particular empty or ‘dummy’ messages, using OTT connection 2450 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:

A1. A method for providing successful handover reports to a radio access network (RAN), the method performed a user equipment (UE) and comprising:
receiving, from the RAN, a configuration for successful handover reporting (SHR) by the UE, wherein the SHR configuration includes at least one of the following:
   a plurality of supervision timer thresholds, with each threshold of the plurality being associated with corresponding measurements configured for the UE; or
   a single supervision timer threshold that is associated with all measurements configured for the UE;
upon transmitting a measurement report to the RAN, initiating a supervision timer based on an initial time value;
upon receiving a handover command from the RAN, determining whether time remaining on the supervision timer is below a particular one of the supervision timer thresholds included in the SHR configuration; and
transmitting a successful handover report to the RAN when the time remaining is below the particular supervision timer threshold.

A2. The method of embodiment A1, wherein:
the SHR configuration includes the plurality of supervision timer thresholds; and
the method further comprises selecting the particular supervision timer threshold based on the measurement report.

A3. The method of embodiment A2, wherein:
the plurality of supervision timer thresholds are associated with a respective plurality of frequencies on which the UE measures signals transmitted by the RAN; and
the particular supervision timer threshold is selected based on the frequencies of the measurements included in the measurement report.

A4. The method of embodiment A3, wherein for the plurality of supervision timer thresholds, the SHR configuration includes a corresponding plurality of one of the following:
identifiers of previously configured measurement objects, with each measurement object identifying a frequency to be measured; or
channel numbers on which the signals are transmitted by the RAN.

A5. The method of embodiment A2, wherein the plurality of supervision timer thresholds are associated with a respective plurality of one of the following: measurement reporting configurations, or measurement identities.

A6. The method of embodiment A5, wherein:
for the plurality of supervision timer thresholds, the SHR configuration includes a corresponding plurality of identifiers of measurement reporting configurations; and
the particular supervision timer threshold is selected based on the measurement reporting configuration associated with the measurement report.

A7. The method of embodiment A5, wherein:
for the plurality of supervision timer thresholds, the SHR configuration includes a corresponding plurality of measurement identities; and
the particular supervision timer threshold is selected based on the measurement identities of measurements included in the measurement report.

A8. The method of embodiment A1, wherein:
the SHR configuration includes the single supervision timer threshold that is associated with all measurements configured for the UE;
the UE is configured with a plurality of measurement configurations, with each measurement configuration including an initial time value for the supervision timer.

A9. The method of embodiment A8, wherein:
the measurement report includes measurements based on a particular one of the measurement configurations; and
the supervision timer is initiated based on the initial time value included in the particular measurement configuration.

A10. The method of embodiment A9, wherein:
each of the plurality of measurement configurations include one or more frequencies of signals to be measured; and
the method further comprises selecting the initial time value based on a match between at least one frequency of measurements included in the measurement report and at least one frequency included in the particular measurement configuration.

A11. The method of any of embodiments A1-A10, wherein the successful handover report includes one or more of the following:
a measurement object identifier associated with measurements that triggered the measurement report;
identifiers of one or more measurements that triggered the measurement report;
an identifier of a reporting configuration associated with a measurement identifier that is associated with the measurements that triggered the measurement report;
a channel number on which the measurements that triggered the measurement report were made; and
the initial time value used when initiating the supervision timer.

A12. The method of embodiment A11, wherein the successful handover report also includes one or more of the following:
values of one or more other timers or counters that triggered the measurement report;
type of signal on which the measurements that triggered the measurement report were made; and
frequency information related to one or more further measurement reports that were triggered while the supervision timer was running.

B1. A method for receiving successful handover reports from a user equipment (UE), the method performed by one or more nodes of a radio access network (RAN) and comprising:
sending, to the UE, a configuration for successful handover reporting (SHR) by the UE, wherein the SHR configuration includes at least one of the following:
   a plurality of supervision timer thresholds, with each threshold of the plurality being associated with corresponding measurements configured for the UE; or
   a single supervision timer threshold that is associated with all measurements configured for the UE;
subsequently receiving a successful handover report from the UE when time remaining on the UE's supervision timer is below a particular supervision timer threshold included in the SHR configuration.

B1a. The method of embodiment B1, further comprising:
receiving a measurement report from the UE;
based on the measurement report, sending a handover command to the UE,
wherein the successful handover report is received responsive to the handover command.

B2. The method of embodiment B1a, wherein:
the SHR configuration includes the plurality of supervision timer thresholds; and
the particular supervision timer threshold is based on the measurement report.

B3. The method of embodiment B2, wherein:
the plurality of supervision timer thresholds are associated with a respective plurality of frequencies on which the UE measures signals transmitted by the RAN; and
the particular supervision timer threshold is based on the frequencies of the measurements included in the measurement report.

B4. The method of embodiment B3, wherein for the plurality of supervision timer thresholds, the SHR configuration includes a corresponding plurality of one of the following:
identifiers of previously configured measurement objects, with each measurement object identifying a frequency to be measured; or
channel numbers on which the signals are transmitted by the RAN;
B5. The method of embodiment B2, wherein the plurality of supervision timer thresholds are associated with a respective plurality of one of the following: measurement reporting configurations, or measurement identities.

B6. The method of embodiment B5, wherein:
for the plurality of supervision timer thresholds, the SHR configuration includes a corresponding plurality of identifiers of measurement reporting configurations;
and the particular supervision timer threshold is based on the measurement reporting configuration associated with the measurement report.

B7. The method of embodiment B5, wherein:
for the plurality of supervision timer thresholds, the SHR configuration includes a corresponding plurality of measurement identities; and
the particular supervision timer threshold is based on the measurement identities of measurements included in the measurement report.

B8. The method of embodiment B1a, wherein:
the SHR configuration includes the single supervision timer threshold that is associated with all measurements configured for the UE;
the method further comprises configuring the UE with a plurality of measurement configurations, with each measurement configuration including an initial time value for the supervision timer.

B9. The method of embodiment B8, wherein:
the measurement report includes measurements based on a particular one of the measurement configurations; and
the UE's supervision timer is initiated based on the initial time value included in the particular measurement configuration.

B10. The method of embodiment B9, wherein:
each of the plurality of measurement configurations include one or more frequencies of signals to be measured; and
the initial time value is included in a measurement configuration that also includes at least one frequency that matches at least one frequency of measurements included in the measurement report.

B11. The method of any of embodiments B1a-B10, wherein the successful handover report includes one or more of the following:
a measurement object identifier associated with measurements that triggered the measurement report;
identifiers of one or more measurements that triggered the measurement report;
an identifier of a reporting configuration associated with a measurement identifier that is associated with the measurements that triggered the measurement report;
a channel number on which the measurements that triggered the measurement report were made; and
the initial time value used to initiate the UE's supervision timer.

B12. The method of embodiment B1, wherein the successful handover report also includes one or more of the following:
values of one or more other timers or counters that triggered the measurement report;
type of signal on which the measurements that triggered the measurement report were made; and
frequency information related to one or more further measurement reports that were triggered while the UE's supervision timer was running.

C1. A user equipment (UE) configured to provide successful handover reports to a radio access network (RAN), the UE comprising:
communication interface circuitry configured to communicate with one or more RAN nodes; and
processing circuitry operatively coupled to the radio transceiver circuitry, whereby the processing circuitry and the radio transceiver circuitry are configured to perform operations corresponding to any of the methods of embodiments A1-A12.

C2. A user equipment (UE) configured to provide successful handover reports to a radio access network (RAN), the UE being further configured to perform operations corresponding to any of the methods of embodiments A1-A12.

C3. A non-transitory, computer-readable medium storing computer-executable instructions that, when executed by processing circuitry of a user equipment (UE) configured to provide successful handover reports to a radio access network (RAN), configure the UE to perform operations corresponding to any of the methods of embodiments A1-A12.

C4. A computer program product comprising computer-executable instructions that, when executed by processing circuitry of a user equipment (UE) configured to provide successful handover reports to a radio access network (RAN), configure the UE to perform operations corresponding to any of the methods of embodiments A1-A12.

D1. A radio access network (RAN) configured to receive successful handover reports from a user equipment (UE), the RAN comprising one or more nodes arranged as:
communication interface circuitry configured to communicate with UEs; and
processing circuitry operatively coupled to the communication interface circuitry, whereby the processing circuitry and the communication interface circuitry are configured to perform operations corresponding to any of the methods of embodiments B1-B12.

D2. A radio access network (RAN) configured to receive successful handover reports from a user equipment (UE), the RAN comprising one or more nodes configured to perform operations corresponding to any of the methods of embodiments B1-B12.

D3. A non-transitory, computer-readable medium storing computer-executable instructions that, when executed by processing circuitry of a radio access network (RAN) configured to receive successful handover reports from a user equipment (UE), configure one or more nodes of the RAN to perform operations corresponding to any of the methods of embodiments B1-B12.

D4. A computer program product comprising computer-executable instructions that, when executed by processing circuitry of a radio access network (RAN) configured to receive successful handover reports from a user equipment (UE), configure one or more nodes of the RAN to perform operations corresponding to any of the methods of embodiments B1-B12.

1.-27. (canceled)

28. A method for providing successful handover reports to a radio access network (RAN), the method performed by a user equipment (UE) and comprising:
receiving, from the RAN, a configuration for successful handover reporting (SHR) by the UE, wherein the SHR configuration includes a single supervision timer threshold that is associated with all measurement objects configured for the UE;
upon transmitting to the RAN a measurement report associated with a first one of the measurement objects, initiating a supervision timer based on an initial time value associated with the first measurement object;
based on receiving from the RAN a handover command to a target cell, determining whether time elapsed from the supervision timer exceeds the supervision timer threshold included in the SHR configuration; and
transmitting a successful handover report to the RAN based on determining that the time elapsed exceeds the supervision timer threshold.

29. The method of claim 28, wherein:
the supervision timer threshold indicates a percentage of an initial time value used to initiate the supervision timer; and
determining whether the time elapsed from the supervision timer exceeds the supervision timer threshold comprises comparing the supervision timer threshold against the time elapsed as a percentage of the initial time value used to initiate the supervision timer.

30. The method of claim 28, wherein the supervision timer is T312 and the supervision timer threshold is thresholdPercentageT312.

31. The method of claim 28, wherein the UE is configured with a plurality of measurement objects, and each measurement object identifies or is associated with the following:
one or more frequencies of signals to be measured, and
an initial time value for the supervision timer.

32. The method of claim 31, wherein:
the method further comprises, upon receiving the handover command, determining whether the target cell is associated with at least one frequency identified by the first measurement object, for which the supervision timer was initiated; and
determining whether time elapsed from the supervision timer exceeds the supervision timer threshold is based on determining that the target cell is associated with at least one frequency identified by the first measurement object.

33. The method of claim 28, wherein the successful handover report includes one or more of the following:
a measurement object identifier associated with measurements that triggered the measurement report;
identifiers of one or more measurements that triggered the measurement report;
an identifier of a reporting configuration associated with a measurement identifier that is associated with the measurements that triggered the measurement report;
a channel number on which the measurements that triggered the measurement report were made; and
the initial time value used when initiating the supervision timer.

34. The method of claim 33, wherein the successful handover report also includes one or more of the following:
values of one or more other timers or counters that triggered the measurement report;
type of signal on which the measurements that triggered the measurement report were made; and
frequency information related to one or more further measurement reports that were triggered while the supervision timer was running.

35. A method for receiving successful handover reports from a user equipment (UE), the method performed by one or more nodes of a radio access network (RAN) and comprising:
sending, to the UE, a configuration for successful handover reporting (SHR) by the UE, wherein the SHR configuration includes a single supervision timer threshold that is associated with all measurement objects configured for the UE; and
subsequently receiving a successful handover report from the UE when time elapsed on a UE supervision timer exceeds the supervision timer threshold included in the SHR configuration.

36. The method of claim 35, wherein:
the supervision timer threshold indicates a percentage of an initial time value used to initiate the supervision timer; and
the successful handover report is received when the time elapsed from the UE supervision timer, as a percentage of the initial time value used to initiate the supervision timer, exceeds the supervision timer threshold.

37. The method of claim 35, wherein the supervision timer is T312 and the supervision timer threshold is thresholdPercentageT312.

38. The method of claim 35, further comprising configuring the UE with a plurality of measurement objects, wherein each measurement object identifies or is associated with the following:
one or more frequencies of signals to be measured, and
an initial time value for the supervision timer.

39. The method of claim 35, further comprising:
receiving a measurement report from the UE; and
based on the measurement report, sending to the UE a handover command to a target cell,
wherein the successful handover report is received responsive to the handover command.

40. The method of claim 39, wherein:
the measurement report is associated with a first measurement object configured for the UE; and
the successful handover report is received when the target cell is associated with at least one frequency identified by the first measurement object.

41. The method of claim 35, wherein the successful handover report includes one or more of the following:
a measurement object identifier associated with measurements that triggered the measurement report;
identifiers of one or more measurements that triggered the measurement report;
an identifier of a reporting configuration associated with a measurement identifier that is associated with the measurements that triggered the measurement report;
a channel number on which the measurements that triggered the measurement report were made; and
the initial time value used to initiate the UE's supervision timer.

42. The method of claim 41, wherein the successful handover report also includes one or more of the following:
values of one or more other timers or counters that triggered the measurement report;
type of signal on which the measurements that triggered the measurement report were made; and
frequency information related to one or more further measurement reports that were triggered while the UE's supervision timer was running.

43. A user equipment (UE) configured to provide successful handover reports to a radio access network (RAN), the UE comprising:
communication interface circuitry configured to communicate with one or more RAN nodes; and
processing circuitry operatively coupled to the communication interface circuitry, wherein the processing circuitry and the communication interface circuitry are configured to:
receive, from the RAN, a configuration for successful handover reporting (SHR) by the UE, wherein the SHR configuration includes a single supervision timer threshold that is associated with all measurement objects configured for the UE;
upon transmission to the RAN of a measurement report associated with a first one of the measurement objects, initiate a supervision timer based on an initial time value associated with the first measurement object;
based on reception from the RAN of a handover command to a target cell, determine whether time elapsed from the supervision timer exceeds the supervision timer threshold included in the SHR configuration; and
transmit a successful handover report to the RAN based on a determination that the time elapsed exceeds the supervision timer threshold.

44. The UE of claim 43, wherein:
the supervision timer threshold indicates a percentage of an initial time value used to initiate the supervision timer; and
the processing circuitry and the communication interface circuitry are configured to determine whether the time elapsed from the supervision timer exceeds the supervision timer threshold based on comparing the supervision timer threshold against the time elapsed as a percentage of the initial time value used to initiate the supervision timer.

45. The UE of claim 43, wherein the successful handover report includes one or more of the following:
a measurement object identifier associated with measurements that triggered the measurement report;
identifiers of one or more measurements that triggered the measurement report;
an identifier of a reporting configuration associated with a measurement identifier that is associated with the measurements that triggered the measurement report;
a channel number on which the measurements that triggered the measurement report were made; and
the initial time value used when initiating the supervision timer.

46. A radio access network (RAN) configured to receive successful handover reports by a user equipment (UE), the RAN comprising one or more RAN nodes arranged as:
communication interface circuitry configured to communicate with the UE; and
processing circuitry operatively coupled to the communication interface circuitry, wherein the processing circuitry and the communication interface circuitry are configured to:
send, to the UE, a configuration for successful handover reporting (SHR) by the UE, wherein the SHR configuration includes a single supervision timer threshold that is associated with all measurement objects configured for the UE; and
subsequently receive a successful handover report from the UE when time elapsed on a UE supervision timer exceeds the supervision timer threshold included in the SHR configuration.

47. The RAN of claim 46, wherein:
the supervision timer threshold indicates a percentage of an initial time value used to initiate the supervision timer; and
the successful handover report is received when the time elapsed from the UE supervision timer, as a percentage of the initial time value used to initiate the supervision timer, exceeds the supervision timer threshold.
